(19) United States
(12) Patent Application Publication
(10) Pub. No.: US 2026/0119845 A1
(43) Pub. Date: Apr. 30, 2026

(54) LOW COMPLEXITY PREFIX PROCESSING IN LANGUAGE MODELING

(71) Applicant: QUALCOMM Incorporated, San Diego, CA (US)

(72) Inventors: Tien Viet NGUYEN, Bridgewater, NJ (US); June NAMGOONG, San Diego, CA (US); Junyi LI, Greentown, PA (US); Gene Wesley MARSH, San Diego, CA (US); Shailesh PATIL, San Diego, CA (US); Kapil GULATI, Belle Mead, NJ (US); Jeya Pradha JEYARAJ, San Diego, CA (US); Oguzhan BASER, Somerset, NJ (US); Vikram GUPTA, San Diego, CA (US)

(21) Appl. No.: 18/929,313

(22) Filed: Oct. 28, 2024

(51) Int. Cl. G06N 3/0475

(52) U.S. Cl. CPC G06N 3/0475

(57) ABSTRACT

Various embodiments include methods, and computing devices that perform the methods, of improving execution of a generative artificial intelligence model. Embodiment methods may include receiving an input prompt that is tokenized into a sequence of input tokens and converted into input embedding vectors. These input embedding vectors may be processed through a collection of i self-attention-based transformer layers extending from a first layer to a transition layer index (i), and a transitional output from the transition layer index (i) may be stored. The transitional output may be applied to a collection of (N−i) cross-attention-based transformer layers extending from the transition layer index (i+1) to the number of layers (N), and output tokens may be generated based on the final cross-attention based hidden state output from the final layer in the number of layers (N).

### BACKGROUND

Recent advancements in artificial intelligence (AI) and machine learning (ML) technologies have resulted in the creation of increasingly sophisticated AI models capable of processing and interpreting complex data structures. These models, often referred to as generative AI models (XM) or large generative AI models (LXMs), find applications across various domains, including natural language processing, computer vision, and speech recognition. XMs and LXMs typically involve intricate computations, including attention mechanisms, to produce coherent and contextually appropriate outputs. These developments raise considerations regarding computational efficiency, particularly in relation to the devices on which these models operate, including resource-constrained computing devices such as smartphones or mobile devices.

### SUMMARY

Further aspects may include a computing device having at least one processor coupled to memory and configured with processor-executable instructions to perform various operations corresponding to the methods summarized above. Further aspects may include a non-transitory processor-readable storage medium having stored thereon processor-executable instructions configured to cause at least one processor to perform various operations corresponding to the method operations summarized above. Further aspects may include a computing device having various means for performing functions corresponding to the method operations summarized above.

In some aspects, the techniques described herein relate to a method of improving operation of a computing system executing a generative model, including: receiving an input prompt that is tokenized into a sequence of input tokens and converted into input embedding vectors; processing the input embedding vectors through a collection of self-attention-based transformer layers extending from a first layer to a transition layer index ( ); storing a final self-attention based hidden state output from the transition layer index (i) layer; applying the final self-attention based hidden state output to a collection of cross-attention-based transformer layers, where N is a number of layers, extending from the transition layer index (+1) to the number of layers to generate a final cross-attention based hidden state output; and generating output tokens based on the final cross-attention based hidden state output from the final layer in the number of layers (N).

In some aspects, the techniques described herein relate to an apparatus for improving operation of a computing system executing a generative model, including: at least one memory including instructions; and at least one processor coupled to the at least one memory and configured to perform operations including: receiving an input prompt that is tokenized into a sequence of input tokens and converted into input embedding vectors; processing the input embedding vectors through a collection of self-attention-based transformer layers extending from a first layer to a transition layer index ( ); storing a final self-attention based hidden state output from the transition layer index (i) layer; applying the final self-attention based hidden state output to a collection of cross-attention-based transformer layers, where N is a number of layers, extending from the transition layer index (+1) to the number of layers to generate a final cross-attention based hidden state output; and generating output tokens based on the final cross-attention based hidden state output from the final layer in the number of layers (N).

In some aspects, the techniques described herein relate to a non-transitory computer-readable medium having stored thereon instructions that, when executed by at least one processor, cause the at least one processor to perform operations including: receiving an input prompt that is tokenized into a sequence of input tokens and converted into input embedding vectors; processing the input embedding vectors through a collection of self-attention-based transformer layers extending from a first layer to a transition layer index ( ); storing a final self-attention based hidden state output from the transition layer index (i) layer; applying the final self-attention based hidden state output to a collection of cross-attention-based transformer layers, where N is a number of layers, extending from the transition layer index (+1) to the number of layers to generate a final cross-attention based hidden state output; and generating output tokens based on the final cross-attention based hidden state output from the final layer in the number of layers (N).

### BRIEF DESCRIPTION OF THE DRAWINGS

The accompanying drawings, which are incorporated herein and constitute part of this specification, illustrate exemplary embodiments of the claims and, together with the general description given and the detailed description, serve to explain the features herein.

FIG. 1 is a component block diagram illustrating example components in a system in package (SIP) that may be included in a computing device and configured to implement some embodiments.

FIG. 2 is a component block diagram illustrating example components in an AI model configured as a transformer model that may operate on a processing or computing system in accordance with some embodiments.

FIG. 3 is a component block diagram illustrating example components in a transformer model that includes a decoder-only architecture suitable for processing input sequences to generate predictions in accordance with some embodiments.

FIG. 4 is a component block diagram illustrating an enhanced transformer model that implements and uses key-value caching techniques in accordance with some embodiments.

FIG. 5 is a component block diagram that illustrates a decoder-only transformer model besides an enhanced transformer model for a side-by-side comparison.

FIG. 6 illustrates an enhanced transformer-based neural network model configured to generate a next token prediction in a sequence of tokens in accordance with some embodiments.

FIGS. 7-10 are process flow diagrams illustrating methods of improving the operation of a computing system executing a generative model (XM) in accordance with various embodiments.

FIG. 11 is a component block diagram illustrating an example computing system suitable for implementing some embodiments.

FIG. 12 is a component block diagram illustrating an example wireless communication device suitable for use with various embodiments.

FIG. 13 is a component diagram of an example server suitable for implementing some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include methods, and computing systems configured to implement the methods, of improving the operations of a computing system executing a generative model (XM). A computing system may be equipped with a processing system and/or components configured to receive an input prompt that is tokenized into a sequence of input tokens and converted into input embedding vectors. The system may process the received input embedding vectors through a collection of i consecutive self-attention-based transformer layers extending from a first layer to a transition layer index (i) layer. The transition layer index (i) may be a value (e.g., 7, 8, etc.) that identifies the layer at which the AI model transitions from the last self-attention based transformer layer to the first cross-attention based transformer layer. In other words, i denotes the number of self-attention based transformer layers. In some embodiments, the system may process the input embedding vectors by computing query (Q), key (K), and value (V) vectors corresponding to each input embedding, performing self-attention computations using the computed Q, K, V vectors, applying normalization and a multi-level perceptron (MLP) to the self-attention output, and generating a hidden state for each layer in the collection of i self-attention-based transformer layers.

The computing system may store a final hidden state vector output from the transition layer index (i) layer (also referred to herein as the “transitional output”), apply the transitional output to a collection of (N−i) cross-attention-based transformer layers extending from the index (i+1) to the number of layers (N), and generate output tokens based on the final cross-attention based hidden state output.

As discussed, the transitional output may be the output from the last self-attention-based transformer layer before the AI model transitions to using cross-attention-based transformer layers. On the other hand, the final cross-attention based hidden state output may be output from the final cross-attention based transformer layer in the number of layers (N).

In some embodiments, a collection of LXMs may be trained with different numbers of self-attention-based transformer layers, identified by the transition layer index (i). Each trained model may share a large portion of its weights with other models to improve memory efficiency. In some embodiments, this may be accomplished by fine-tuning the models based on a shared base model using Low Rank Adaptation (LoRa) techniques. This may allow for multiple models to be trained with different values of the transition layer index (i). In some embodiments, each model may be enhanced to handle specific tasks or topics.

In some embodiments, applying the transitional output to the collection of (N−i) cross-attention-based transformer layers may include determining one or more query (Q) vectors from the previous layer's output, determining one or more key (K) vectors and one or more value (V) vector from the transitional output, performing cross-attention computations using the one or more Q vectors, the one or more K vectors, and the one or more V vectors, applying normalization and an MLP to the cross-attention output, and generating a hidden state for each layer in the collection of (N−i) cross-attention-based transformer layers. In some embodiments, the computing system may generate the output tokens by computing final output token probabilities using the final cross-attention based hidden state output from the final layer, applying a softmax function to obtain a probability distribution over a vocabulary, and sampling an output token from the probability distribution.

In some embodiments, the computing system may be configured to determine model parameters (e.g., number of layers (N), hidden state size, attention head configurations, etc.) for the generative model. In some embodiments, the computing system may classify the received prompt based on the sensitivity of the output to the transition layer index (i) layer, use the classified prompt to select a generative model from a multitude of trained generative model models configured with different transition layer index (i) values, and use the selected model to process the input prompt.

In some embodiments, the computing system may use a classifier that analyzes each input prompt and determines the most suitable model based on the transition layer index (i) value. In some embodiments, the classifier may assign each input prompt to a particular trained model with the most appropriate transition layer index (i) based on the complexity of the prompt and the type of task being performed. In some embodiments, the classified model may be used to generate the output tokens.

In some embodiments, in addition to selecting a model, the computing system may allow the client device to specify a value for the transition layer index (i). For example, a client device of the system may analyze the prompt and select the appropriate model to determine the transition layer index (i) value for simpler or more complex input prompts. The client may indicate the selected transition layer index (i) value in its request to a server in the system. Based on this value, the server may select the appropriate model and perform further processing for prompt generation.

The term “computing device” is used herein to refer to a single device or combination of devices that includes but not limited to any one or all of personal computing devices, personal computers, workstations, laptop computers, Netbooks, Ultrabook, tablet computers, mobile communication devices, smartphones, user equipment (UE), personal data assistants (PDAs), palm-top computers, wireless electronic mail receivers, multimedia internet-enabled cellular telephones, media and entertainment systems, gaming systems (e.g., PlayStation™, Xbox™, Nintendo Switch™), media players (e.g., DVD players, Roku™, apple TV™), digital video recorders (DVRs), portable projectors, 3D holographic displays, wearable devices (e.g., earbuds, smartwatches, fitness trackers, augmented reality (AR) glasses, head-mounted displays, etc.), vehicle systems such as drones, automobiles, motorcycles, connected vehicles, electric vehicles, automotive displays, advanced driver-assistance systems (ADAS), etc., cameras (e.g., surveillance cameras, embedded cameras), smart devices (e.g., smart light bulbs, smartwatches, thermostats, smart glasses, etc.), Internet of Things (IOT) devices, other similar devices that include a programmable processor or processing system that may be configured to provide the functionality of various embodiments.

The term “computing system” is used herein to refer any combination or configuration of computing devices, including a single device, a combination of devices, a distributed network of devices, and systems that include combinations of different devices or processors that together form a cohesive network to carry out the tasks and functions described in this application. A computing system may include configurations such as a local device interacting with a server or other components in the cloud to process data. For example, in split computing configurations, portions of a task may be processed on a local client device (e.g., smartphone, tablet, vehicle system) while other portions of the task may be processed on a remote server or in the cloud (e.g., for a more resource-efficient and scalable computation, etc.).

The term “system on chip” (SoC) is used herein to refer to a single integrated circuit (IC) chip that contains multiple resources or independent processors integrated on a single substrate. A single SoC may contain circuitry for digital, analog, mixed-signal, and radio-frequency functions. A single SoC may include at least one processor of a processing system that includes any number of general-purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.). For example, an SoC may include an applications processor that operates as the SoC's main processor, central processing unit (CPU), microprocessor unit (MPU), arithmetic logic unit (ALU), etc. An SoC processing system may also include software for controlling integrated resources and processors, as well as for controlling peripheral devices.

The term “system in a package” (SIP) is used herein to refer to a single module or package that contains multiple resources, computational units, cores, or processors on two or more IC chips, substrates, or SoCs. For example, an SIP may include a single substrate on which multiple IC chips or semiconductor dies are stacked vertically. Similarly, the SIP may include one or more multi-chip modules (MCMs) on which multiple ICs or semiconductor dies are packaged into a unifying substrate. A SIP may also include multiple independent SOCs coupled together via high-speed communication circuitry and packaged in close proximity, such as on a single motherboard, in a single UE, or in a single CPU device. The proximity of the SoCs facilitates high-speed communications and the sharing of memory and resources.

The term “neural network” is used herein to refer to an interconnected group of processing nodes (or neuron models) that collectively operate as a software application or process that controls a function of a computing device and/or generates an overall inference result as output. Individual nodes in a neural network may attempt to emulate biological neurons by receiving input data, performing simple operations on the input data to generate output data, and passing the output data (also called “activation”) to the next node in the network. Each node may be associated with a weight value that defines or governs the relationship between input data and output data. A neural network may learn to perform new tasks over time by adjusting these weight values. In some cases, the overall structure of the neural network and/or the operations of the processing nodes do not change as the neural network learns a task. Rather, learning is accomplished during a “training” process in which the values of the weights in each layer are determined. As an example, the training process may include causing the neural network to process a task for which an expected/desired output is known, comparing the activations generated by the neural network to the expected/desired output, and determining the values of the weights in each layer based on the comparison results. After the training process is complete, the neural network may begin “inference” to process a new task with the determined weights.

The term “inference” is used herein to refer to a process that is performed at runtime or during the execution of the software application program corresponding to the neural network to produce an inference result from input data. Inference may include traversing the processing nodes in the neural network along a forward path to produce one or more output values, which collectively represent the overall activation or “inference result” of the neural network.

The term “multi-level perceptron (MLP)” is used herein to refer to a specific type of neural network characterized by a feedforward, densely or partially connected architecture. An MLP may include an input layer, one or more hidden layers, and an output layer. Each processing node in the MLP may be connected to every node in the subsequent layer, with connections governed by weight values. An MLP may include nonlinear activation functions that capture complex relationships in the data, and these activations may be passed as input to the next layer of processing nodes. Said another way, an MLP may process input data through its layers, which may include applying operations and nonlinear activation functions to capture complex relationships before generating the final output

Deep neural networks, such as MLPs that include multiple hidden layers, implement a layered architecture in which the output of one layer of nodes becomes the input for the next layer. Computations in a deep neural network may be distributed over a population of processing nodes that make up a computational chain. Deep neural networks may also include activation functions and sub-functions (e.g., a rectified linear unit that cuts off activations below zero, etc.) between the layers. Said another way, the computations may be distributed across the layers of the deep neural network, with activation functions applied between layers to introduce non-linearity. The first layer of nodes of a deep neural network may be referred to as an input layer. The final layer of nodes may be referred to as an output layer. The layers in between the input and final layer may be referred to as intermediate layers, hidden layers, or black-box layers. Deep neural networks may process data in stages and refine the data in each layer to produce an accurate inference result.

Each layer in a neural network may receive inputs from multiple preceding layers, creating complex, multi-layered pathways through the network. Multiple layers may feed into a single layer. For ease of reference, some of the embodiments are described with reference to a single input or single preceding layer. However, it should be understood that the operations disclosed and described in this application may be applied to each of multiple inputs to a layer and multiple preceding layers.

The term “transformer” is used herein to refer to a specific type of neural network that includes an encoder and/or a decoder and is particularly well-suited for sequence data processing. A transformer may include self-attention mechanisms that weigh the relevance of different elements within an input sequence and allow the network to capture long-range dependencies. Transformers may process input sequences in parallel across multiple self-attention components and may include MLP layers to refine the output data. The transformer's specialized architecture allows for efficient and effective processing of sequence data, as is often foundational in constructing generative AI models.

The term “artificial intelligence (AI) model” is used herein to refer to a software application or process that uses one or more neural networks (e.g., transformers, MLPs, etc.) to perform tasks such as generating inference results from input data. An AI model may organize processing nodes into layers, with each node processing input data and passing the output to subsequent nodes. An AI model may integrate and use multiple different neural networks or networks network architectures to perform complex tasks, such as sequence data processing, pattern recognition, and decision-making.

The term “generative AI model” (XM) is used herein to refer to a category of AI models configured to generate new content (e.g., text, images, audio, etc.) based on patterns learned from training data. Generative AI models may include various neural network architectures, such as generative adversarial networks (GANs), variational autoencoders (VAEs), and transformers, to produce original outputs by sampling from learned data distributions. These models may operate independently or as part of larger systems (e.g., large generative AI models, etc.) to further improve the quality and relevance of generated content.

The term “large generative AI model” (LXM) is used herein to refer to an advanced computational framework that includes any of a variety of specialized AI models including, but not limited to, large language models (LLMs), large speech models (LSMs), large/language vision models (LVMs), vision language models (VLMs)), hybrid models, and multi-modal models. An LXM may include multiple layers of neural networks (e.g., RNN, LSTM, transformer, etc.) with millions, billions, or trillions of parameters. LXMs may support complex tasks (e.g., text summarization, translation, conversational agents, etc.) by providing direct answers based on expansive internal knowledge. LXMs may operate independently or be integrated into larger systems.

The performance of an XM system may depend on the quality and relevance of the input context, which is often provided as a textual prompt that includes tokens. The number of tokens an XM may process is often limited. Exceeding the token limit may require truncating or altering the input sequence.

The term “embedding layer” is used herein to refer to a specialized layer within a neural network that transforms tokens (or continuous or discrete categorical values) into continuous, high-dimensional vectors that encode various attributes and relationships of the tokens in a manner that is conducive to the tasks the AI model is configured to perform or which allows the AI model to process complex data more efficiently. The embedding layer may convert tokens (typically low-dimensional entities) into high-dimensional vectors or convert high-dimensional data into low-dimensional vectors (e.g., using “dimensionality reduction” techniques, etc.). The embedding layer is typically the first stage in a neural network and provides the input for subsequent layers.

The term “embedding vector” is used herein to refer to a high-dimensional vector representation of input tokens and is typically generated by the embedding layer in a neural network. Embedding vectors may encode token attributes and relationships and may be used as inputs for subsequent layers in the AI model.

The term “token” is used herein to refer to a unit of information that an AI model may read as input. Each token may represent any of a variety of different data types. For example, in text-centric models such as in LLMs, each token may represent one or more textual elements such as a paragraph(s), sentence(s), clause(s), word(s), sub-word(s), character(s), etc. In models designed for auditory data, such as LSMs, each token may represent a feature extracted from audio signals, such as a phoneme, spectrogram, temporal dependency, Mel-frequency cepstral coefficients (MFCCs) that represent small segments of an audio waveform, etc. In visual models such as LVM, each token may correspond to a portion of an image (e.g., pixel blocks), sequences of video frames, etc. In hybrid systems that combine multiple modalities (text, speech, vision, etc.), each token may be a complex data structure that encapsulates information from various sources (e.g., the token may include both textual and visual information, each of which independently contributes to the token's overall representation in the AI model). Tokens are typically preprocessed and tokenized so that they are compatible with the AI model architecture and often form the basis for generating embeddings and producing neural network outputs.

Each token may be converted into a numerical vector via the embedding layer. Each vector component (e.g., numerical value, parameter, etc.) may encode an attribute, quality, or characteristic of the original token. The vector components may be adjustable parameters that are iteratively refined during the AI model training phase to improve the AI model's performance during subsequent operational phases. The numerical vectors may be high-dimensional space vectors (e.g., containing 300, 1K, 3K, or 10K dimensions, etc.) in which each dimension in the vector captures a unique attribute, quality, or characteristic of the token. For example, dimension 1 of the numerical vector may encode the frequency of a word's occurrence in a corpus of data, dimension 2 may represent the pitch or intensity of the sound of the word at its utterance, dimension 3 may represent the sentiment value of the word, etc. Such intricate representation in high-dimensional space may help the AI model understand the semantic and syntactic subtleties of its inputs. The vectors may be processed sequentially through the AI model, which may include structures such as transformers or recurrent neural networks (RNNs) that handle sequence data.

The term “sequence data processing” is used herein to refer to techniques or technologies for handling ordered sets of tokens in a manner that preserves their original sequential relationships and captures dependencies between various elements within the sequence. The resulting output may be a probabilistic distribution or a collection of probability values, each corresponding to a “possible succeeding token” in the existing sequence.

The term “Key-Value (KV) cache” is used herein to refer to a memory storage mechanism in transformer models that stores key and value vectors generated during input sequence processing. The KV cache may allow for efficient reuse of the key and value vectors in subsequent computations to reduce repetitive calculations and allow parallel processing across multiple units.

The term “prefilling” is used herein to refer to the initial stage in the processing of input prompts by an AI model in which the tokens in the input prompt are processed to generate the initial hidden state vectors. For example, each token in the sequence may be converted into an embedding vector that is passed through the layers of the transformer model to generate the initial hidden state vectors. These vectors may be foundational representations of the input data that are used later in the autoregressive generation phase to produce final outputs.

The term “autoregressive generation” is used herein to refer to a stage in the processing of input prompts by an AI model in which the AI model sequentially generates output tokens based on previously generated tokens (e.g., considering the context provided by all preceding tokens, etc.) and the relationships learned within the AI model. The autoregressive generation phase follows the prefilling phase and may use previously generated hidden state vectors and embeddings.

The term “self-attention mechanism” is used herein to refer to a process within a neural network, particularly in transformer models, that allows the AI model to weigh the importance of different tokens in an input sequence relative to each other. The self-attention mechanism may determine attention scores for each token and determine how much focus should be placed on other tokens in the sequence. As part of these operations, the self-attention mechanism may identify dependencies and relationships across the input sequence for a more relevant contextual understanding of the input sequence.

The term “self-attention-based transformer layer” is used herein to refer to a transformer layer that includes self-attention mechanisms that weigh the importance of different tokens. A self-attention-based transformer layer may also include MLP components that apply non-linear transformations and normalization components that standardize the outputs.

The term “cross-attention mechanism” is used herein to refer to a process within a neural network, particularly in transformer models, that allows the AI model to integrate and align information from two distinct sequences. Unlike self-attention mechanisms, which focus on identifying dependencies and relationships within a single sequence, cross-attention mechanisms may operate between two separate sequences (e.g., the “query” and “key-value” sequences, etc.).

The term “cross-attention-based transformer layer” is used herein to refer to a transformer layer that includes cross-attention mechanisms that align and integrate information from two different sequences. The cross-attention mechanisms may determine relationships between a query sequence and a separate key-value sequence to allow the AI model to generate more relevant outputs.

The term “transitional output” is used herein to refer to a hidden state vector (or other information structure) that is generated by the last self-attention-based transformer layer in the transformer before transitioning to cross-attention-based transformer layers of the transformer. The transitional output may include or characterize the accumulated context from the input sequence and may be used as input for a subsequent layer, network, processing node, etc.

The term “final cross-attention based hidden state output” is used herein to refer to the hidden state vector (or other information structure) that is generated by the last cross-attention-based transformer layer of the transformer. The final cross-attention based hidden state output may combine internal context from the self-attention mechanisms and external context from the cross-attention mechanisms to generate the final output tokens.

The term “input tokens” is used herein to refer to units of data fed into an AI model (e.g., XM, LXM, etc.). Input tokens may include or represent words, sub-words, phonemes, pixel blocks, etc., depending on the modality of the AI model. The input tokens may be used to generate the embeddings and subsequent outputs.

The term “output tokens” is used herein to refer to units of data generated by an AI model based on the processing of input tokens. Output tokens may include or represent generated text, predicted words, synthesized audio, image components, and other information inferred based on the learned patterns of the AI model.

The term “normalization” is used herein to refer to techniques applied within a neural network to standardize output values so that they remain within a fixed dynamic range. Normalization methods, such as layer normalization, batch normalization, and RMS normalization, adjust the scale and distribution of data to stabilize training and improve performance.

The term “projection” is used herein to refer to the process of mapping input features into a different vector space using linear or non-linear transformations. Projections may generate query, key, and value vectors in attention mechanisms and transform embeddings within neural network layers.

The term “query (q) vector” is used herein to refer to a vector (or other information structure) that represents an input token or feature in an attention mechanism within a transformer model. The query vector may identify relevant connections within a sequence by comparing itself to key vectors and determining how much focus should be placed on other tokens when generating an output.

The term “key (k) vector” is used herein to refer to a vector (or other information structure) that represents a token or feature in an attention mechanism within a transformer model. The key vector serves as a reference against which query vectors are compared to identify important tokens within a sequence.

The term “value (v) vector” is used herein to refer to a vector (or other information structure) that represents data associated with a token or feature in an attention mechanism within a transformer model. The value vector may include the content or features that contribute to the final output of the attention mechanism. The content or features may be weighted and combined based on attention scores.

The term “logits” is used herein to refer to unnormalized output values generated by a neural network, typically in the final layer, before applying a softmax function or other normalization techniques. Logits may include the raw predictions of the model that may be interpreted as scores associated with each possible class or outcome, such as the likelihood of a specific token being the next in a sequence. For example, in a language model, logits may represent the model prediction of the next word in a sentence before it is converted into a probability distribution. These logits may be passed through a softmax function to produce a probability distribution over all possible outcomes, which the AI model may use to sample the most likely next token or select the best response in a classification task. Logits may also be used to compute loss functions during training.

The term “softmax” is used herein to refer to a function or algorithm that implements a mathematical function that converts a vector of logits (raw, unnormalized output scores) into a probability distribution. These operations may include exponentiating each logit by raising the base of the natural logarithm (Euler's number, e) to the power of the logit, normalizing the resulting values by dividing each by the sum of all exponentiated logits, and generating a probability distribution in which the probabilities sum to one. Some embodiments may include components configured to apply the softmax function to the output layer of a neural network to interpret the logits as probabilities over possible classes or next tokens in a sequence.

The term “vocabulary” is used herein to refer to the complete set of tokens or distinct words that an AI model, such as an XM, may recognize and process. A vocabulary may include all potential tokens on which the AI model has been trained, including words, sub-words, characters, or other meaningful units that form the foundation of input and output sequences. Each token in the vocabulary may be associated with a unique identifier or index that allows the AI model to reference and use the token during content processing and generation (e.g., text, sounds, images, videos). The size of the vocabulary may directly influence the model's performance, with a larger vocabulary providing more detailed understanding and generation capabilities. In contrast, a smaller vocabulary may allow for faster processing and reduced memory usage. Tokens within the vocabulary are typically preprocessed and tokenized during the training phase.

Some embodiments include computing devices, processing systems, and/or components configured to enhance the performance and capabilities of a computing device executing a generative AI model (XM). In some embodiments, the processing system may use advanced technologies and techniques such as KV caching, causal attention, and cross-attention to address various technical challenges inherent in conventional generative AI models, particularly those based on transformer architectures.

Conventional transformer-based generative AI models include certain characteristics that could present several technical challenges and could have a significant negative impact on the performance of the computing devices on which they run. These models often require processing large datasets, such as sequences containing tens of thousands to millions of tokens, particularly during the prefilling and autoregressive generation phases. Processing such extensive input sequences may require substantial computational resources (e.g., memory, processing, power, etc.). As sequence length and complexity increase, the computational demands on the system intensify, potentially resulting in increased latency, reduced throughput, or other conditions that degrade the overall performance and functionality of the computing device.

In addition, conventional solutions may not adequately maintain contextual relevance throughout the content generation process. In tasks such as text generation, translation, or summarization, it may be necessary to retain and accurately apply contextual information from earlier parts of the sequence to ensure coherence and logical consistency. However, conventional transformer-based generative AI model solutions may not effectively manage this context, especially with long or complex sequences. This may result in outputs that are disjointed, irrelevant, or contextually inaccurate, reducing the overall quality and reliability of the generated content.

Conventional solutions also do not adequately manage transitions between different processing layers, particularly transitions from self-attention based transformer layers that focus on internal sequence relationships to cross-attention based transformer layers that incorporate external context. The seamless integration of these layers is important for preserving the integrity of the data processing pipeline, particularly for transformer models that rely heavily on attention mechanisms to identify and manage dependencies between tokens. Inefficiencies in these transitions may disrupt the data processing flow, increase latency, reduce throughput, and negatively affect the accuracy and relevance of the model's outputs.

Various embodiments include computing devices, processing systems, and/or components configured to overcome these and other technical challenges by, for example, using a KV cache to improve the computation of embeddings for tokens in a sequence or causing an XM to transition from i self-attention-based transformer layers to (N−i) cross-attention-based transformer layers at a designated transition layer index (i).

An AI model (e.g., transformer, etc.) may include a prefilling phase and an autoregressive generation phase. While operating in the prefilling phase mode, the AI model may process tokens in an input prompt in parallel, sequentially, by chunking, etc. For example, the AI model may process tokens in an input prompt in parallel in parallel to allow for the simultaneous generation of the query (q), key (k), and value (v) vectors for each token. These vectors may be used by the self-attention mechanisms to, for example, determine how much focus each token should place on other tokens in the input sequence.

In addition, while operating in the prefilling phase mode, the AI model may convert each token tₖ in the input sequence into an input embedding vector xₖ and apply these input embedding vectors xₖ to the transformer model, which comprises multiple transformer layers, to generate hidden state vectors

$${h}_{k}^{l}$$

at each layer l. The term “embeddings” and the “embedding vectors” will be used interchangeably with “hidden state vectors” denoted by

$${h}_{k}^{l} .$$

For example, applying the input embedding vectors xₖ to a first transformer layer may generate hidden state vectors (e.g.,

$${h}_{0}^{1} , {h}_{1}^{1} , … , {h}_{98}^{1} , {h}_{99}^{1} ) .$$

Subsequent layer may further process the embeddings from the first transformer layer

$$( {h}_{0}^{1} , {h}_{1}^{1} , … , {h}_{98}^{1} , {h}_{99}^{1} )$$

to produce higher-level representations of the hidden state vectors (e.g.,

$${h}_{0}^{2} , {h}_{1}^{2} , … , {h}_{98}^{2} , {h}_{99}^{2} ) ,$$

and so forth. In other words, the input embedding vector may be applied to the transformer model, which may include multiple transformer layers, to produce hidden state vectors at each layer, and the transitional output from the transition layer index (i) layer may be determined, captured, stored, and used to facilitate the transition from self-attention-based transformer layers to cross-attention-based transformer layers.

The transition from self-attention based transformer layer to cross-attention based transformer layer at the transition layer index (i) may allow the model to handle complex input prompts more effectively and generate output tokens that are more contextually accurate. While operating in the autoregressive generation phase, the AI model may generate tokens sequentially, and each new token may be appended to the existing sequence and processed to generate the next token. As such, this phase may rely on attention mechanisms to identify dependencies and relationships between the next token with the hidden state vectors established during the prefilling phase. For example, the causal attention mechanism may be configured so that the hidden state vector

$${h}_{k}^{l}$$

for the k-th token depends only on the embeddings from previous layers corresponding to previous tokens

$$\{ {h}_{0}^{l - 1} , {h}_{1}^{l - 1} , … , {h}_{k - 1}^{l - 1} \} ,$$

and the current token

$${h}_{k}^{l - 1} .$$

This may allow the system to efficiently maintain the temporal order of the sequence and capture dependencies between tokens.

The AI model may store the key and value vectors for each token generated during the prefilling phase in the KV cache and reuse the key and value vectors when computing embeddings for future tokens. This may reduce redundant computations and allow for parallel processing across multiple processing systems (e.g., multiple GPUs, etc.). The KV cache may support both the prefilling and autoregressive phases by providing quick access to pre-computed vectors and streamlining the generation process, which may be particularly important as the AI model transitions from the self-attention based transformer layers to the cross-attention based transformer layers.

In some embodiments, the processing system may classify the received prompts based on the sensitivity of the output to the transition layer index (i) layer and select one of a plurality of trained XMs configured with different index values based on the classified prompt. Part of the processing system may reside on the local client (e.g., a cell phone, or a car), while the rest of the processing system may reside on the server in the cloud. This may help reduce the workload on the server, so that the server can serve more clients at the same time. A local client may determine the value for the transition layer index (i) and send the selected value for the transition layer index (i), along with the received prompt, to the server. The server chooses the trained XM configured with the transition layer index (i) indicated by the client for generation in response to the prompt received from the client. In another example, the client determines the task (for example, summarization, math reasoning, sentimental analysis) from the received prompt, and sends the task classification result to the cloud along with the received prompt. Then, the server on the cloud determines the transition layer index (i), based on the task classified by the client. The server chooses the trained XM configured with the determined transition layer index (i) for generation in response to the prompt received from the client.

In some embodiments, the processing system may be configured to support adaptive algorithms that improve the AI model's ability to dynamically understand context and user behavior. These algorithms may operate in conjunction with the core XM functionalities to continuously refine or fine-tune the AI model based on new input data and user interactions to improve the relevance and accuracy of the AI model outputs.

As discussed, some embodiments include computing devices equipped with components that are configured to mitigate the above-described technical challenges to improve the performance and efficiency of the XMs and computing devices that use XMs without causing a significant negative or user-perceivable impact on the performance or energy consumption characteristics of the computing device.

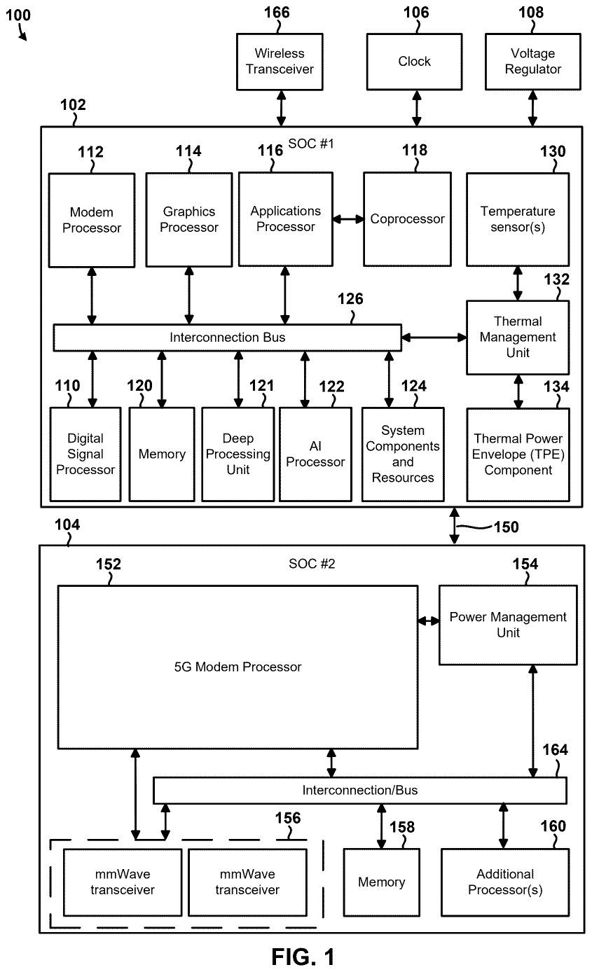

Various embodiments may be implemented on a number of single-processor and multiprocessor computer systems, including a system-on-chip (SOC) or system in a package (SIP). FIG. 1 illustrates an example computing system or SIP 100 architecture that may be used in mobile computing devices implementing a continuous speech-monitoring artificial intelligence (AI) system in accordance with various embodiments.

With reference to FIG. 1, the illustrated example SIP 100 includes two SOCs 102, 104, a clock 106, a voltage regulator 108, and a wireless transceiver 166. The first and second SOC 102, 104 may communicate via interconnection bus 150. The various processors 110, 112, 114, 116, 118, 121, 122, may be interconnected to each other and to memory 120, system components and resources 124, and a thermal management unit 132 via an interconnection bus 126, which may include advanced interconnects such as high-performance networks-on-chip (NOCs). Similarly, the processor 152 may be interconnected to the power management unit 154, the mmWave transceivers 156, memory 158, and various additional processors 160 via the interconnection bus 164. These interconnection buses 126, 150, 164 may include an array of reconfigurable logic gates and/or implement a bus architecture (e.g., CoreConnect, AMBA, etc.). Communications may be provided by advanced interconnects, such as NOCs.

In various embodiments, any or all of the processors 110, 112, 114, 116, 121, 122, in the system may operate as the SoC's main processor, central processing unit (CPU), microprocessor unit (MPU), arithmetic logic unit (ALU), etc. One or more of the coprocessors 118 may operate as the CPU.

In some embodiments, the first SOC 102 may operate as the central processing unit (CPU) of the mobile computing device that carries out the instructions of software application programs by performing the arithmetic, logical, control and input/output (I/O) operations specified by the instructions. In some embodiments, the second SOC 104 may operate as a specialized processing unit. For example, the second SOC 104 may operate as a specialized 5G processing unit responsible for managing high volume, high speed (e.g., 5 Gbps, etc.), and/or very high-frequency short wavelength (e.g., 28 GHz mmWave spectrum, etc.) communications.

The first SOC 102 may include a digital signal processor (DSP) 110, a modem processor 112, a graphics processor 114, an application processor 116, one or more coprocessors 118 (e.g., vector co-processor, CPUCP, etc.) connected to one or more of the processors, memory 120, deep processing unit (DPU) 121, artificial intelligence processor 122, system components and resources 124, an interconnection bus 126, one or more temperature sensors 130, a thermal management unit 132, and a thermal power envelope (TPE) component 134. The second SOC 104 may include a 5G modem processor 152, a power management unit 154, an interconnection bus 164, mmWave transceivers 156, memory 158, and various additional processors 160, such as an applications processor, packet processor, etc.

Each processor 110, 112, 114, 116, 118, 121, 122, 121, 122, 152, 160 may include one or more cores, and each processor/core may perform operations independent of the other processors/cores. For example, the first SOC 102 may include a processor that executes a first type of operating system (e.g., FreeBSD, LINUX, OS X, etc.) and a processor that executes a second type of operating system (e.g., MICROSOFT WINDOWS 11). In addition, any or all of the processors 110, 112, 114, 116, 118, 121, 122, 121, 122, 152, 160 may be included as part of a processor cluster architecture (e.g., a synchronous processor cluster architecture, an asynchronous or heterogeneous processor cluster architecture, etc.).

Any or all of the processors 110, 112, 114, 116, 118, 121, 122, 121, 122, 152, 160 may operate as the CPU of the mobile computing device. In addition, any or all of the processors 110, 112, 114, 116, 118, 121, 122, 121, 122, 152, 160 may be included as one or more nodes in one or more CPU clusters. A CPU cluster may be a group of interconnected nodes (e.g., processing cores, processors, SOCs, SIPs, computing devices, etc.) configured to work in a coordinated manner to perform a computing task. Each node may run its own operating system and contain its own CPU, memory, and storage. A task that is assigned to the CPU cluster may be divided into smaller tasks that are distributed across the individual nodes for processing. The nodes may work together to complete the task, with each node handling a portion of the computation. The results of each node's computation may be combined to produce a final result. CPU clusters are especially useful for tasks that can be parallelized and executed simultaneously. This allows CPU clusters to complete tasks much faster than a single, high-performance computer. Additionally, because CPU clusters are made up of multiple nodes, they are often more reliable and less prone to failure than a single high-performance component.

The first and second SOC 102, 104 may include various system components, resources, and custom circuitry for managing sensor data, analog-to-digital conversions, wireless data transmissions, and for performing other specialized operations, such as decoding data packets and processing encoded audio and video signals for rendering in a web browser. For example, the system components and resources 124 of the first SOC 102 may include power amplifiers, voltage regulators, oscillators, phase-locked loops, peripheral bridges, data controllers, memory controllers, system controllers, Access ports, timers, and other similar components used to support the processors and software clients running on a computing device. The system components and resources 124 may also include circuitry to interface with peripheral devices, such as cameras, electronic displays, wireless communication devices, external memory chips, etc.

The first and/or second SOCs 102, 104 may further include an input/output module (not illustrated) for communicating with resources external to the SOC, such as a clock 106, a voltage regulator 108, and a wireless transceiver 166 (e.g., cellular wireless transceiver, Bluetooth transceiver, etc.). Resources external to the SOC (e.g., clock 106, voltage regulator 108, wireless transceiver 166) may be shared by two or more of the internal SOC processors/cores.

In addition to the example SIP 100 discussed above, various embodiments may be implemented in various computing systems, including a single processor, multiple processors, multicore processors, or any combination thereof.

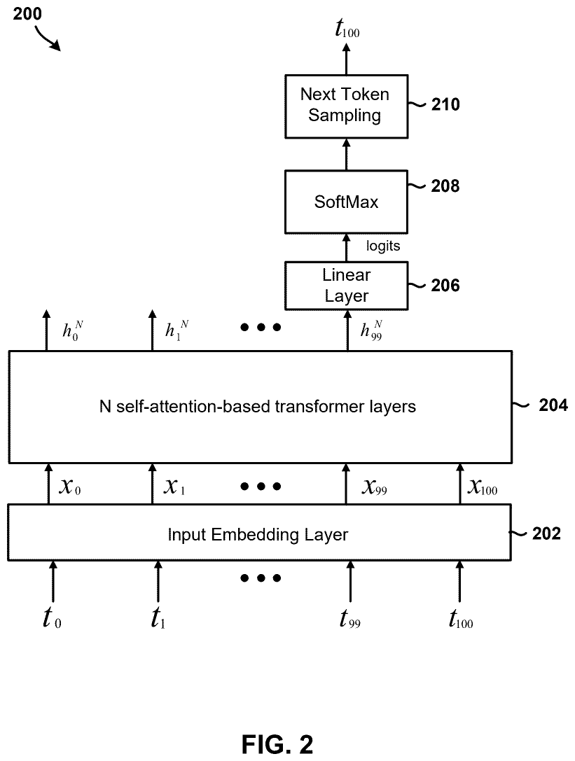

FIG. 2 illustrates example components in an AI model configured as a transformer model 200 that may operate on a processing or computing system (e.g., SIP 100, SOCs 102, 104, etc.) in accordance with some embodiments. With reference to FIGS. 1 and 2, the transformer model 200 may sequentially process input data through various stages, with each stage contributing to the generation of the final output token. The transformer model 200 may include an input embedding layer 202, a series of N self-attention-based transformer layers 204, a linear layer 206, a softmax 208 layer, and a next token sampling component 210.

The computing system may receive or generate an input sequence that includes input tokens (t₀, t₁ . . . , t₉₉). The computing system may apply the input sequence to the input embedding layer 202, which may convert the input tokens into input embedding vectors (x₀, x₁, . . . , x₉₉). These input embedding vectors may be continuous representations that encode the information (e.g., semantic and syntactic information, etc.) of the tokens. The N self-attention-based transformer layers 204 may apply self-attention mechanisms to identify dependencies among the tokens, determine their relative importance, and generate a series of hidden state vectors

$$( {h}_{0}^{N} , {h}_{1}^{N} , … , {h}_{99}^{N} )$$

that abstract the features of the input sequence. The linear layer 206 may transform the hidden state vectors into logits, which are raw scores representing the likelihood of each possible next token in the sequence. The softmax 208 component may convert the logits into a probability distribution, and the next token sampling component 210 may evaluate this distribution to sample (or generate a prediction for) the next token based on the computed probabilities. The computing system may add the sampled token tio₁ to the input tokens to obtain (t₀, t₁ . . . , t₉₉, t₁₀₀) and repeat the described operations to continue generating subsequent tokens in an autoregressive manner.

The data may flow through a transformer processing pipeline of the transformer model 200, starting from the input tokens (t₀, t₁, . . . , t₉₉) through the input embedding layer 202, the N self-attention-based transformer layers 204, the linear layer 206, the softmax 208, and the next token sampling 210 components to generate a prediction for the next token t₁₀₀. The input embedding layer 202 may convert each input token tₖ (e.g., the k-th token output by a tokenizer) into a corresponding input embedding vector xₖ. These embedding vectors may serve as the initial representations of the tokens in a continuous vector space, storing the semantic and syntactic information of their corresponding tokens in a format that may be processed efficiently by subsequent layers in the transformer model 200.

The N self-attention-based transformer layers 204 may receive and apply the sequence of input embedding vectors (x₀, x₁, . . . , x₉₉) to a series of transformer layers. Each transformer layer may apply a self-attention mechanism to the hidden state vector output from the previous transformer layer to identify dependencies between the tokens and weigh the importance of each token relative to others in the sequence. The input to the l-th transformer layer may be a collection of hidden state vectors

$$( {h}_{0}^{l - 1} , {h}_{1}^{l - 1} , … , {h}_{99}^{l - 1} )$$

output by the (l−1)-th transformer layer. The output of the l-th transformer layer may be a collection of hidden state vectors

$$( {h}_{0}^{l} , {h}_{1}^{l} , … , {h}_{99}^{l} )$$

representing increasingly abstracted features of the input sequence. In other words, the l-th transformer layer transforms the hidden state vectors

$$( {h}_{0}^{l - 1} , {h}_{1}^{l - 1} , … , {h}_{99}^{l - 1} )$$

into the hidden state vectors

$$( {h}_{0}^{l} , {h}_{1}^{l} , … , {h}_{99}^{l} ) .$$

These hidden state vectors may be passed from one layer to the next to build a rich contextual representation of the entire sequence.

The linear layer 206 may receive the final hidden state vectors

$$( {h}_{0}^{N} , {h}_{1}^{N} , … , {h}_{99}^{N} )$$

produced by the final transformer layer of the N self-attention-based transformer layers 204. The linear layer 206 may apply linear transformations to the hidden state vectors to generate logits (i.e., numerical values representing the unnormalized probabilities for each possible next token in the sequence).

The softmax 208 may receive and apply the logits to a softmax function, converting the logits into probability values that indicate the likelihood of each possible next token based on the information captured by the model from the previous tokens in the sequence. The next token (t₁₀₀) may be sampled based on these probabilities and added to the sequence so that the model may continue the autoregressive generation of subsequent tokens.

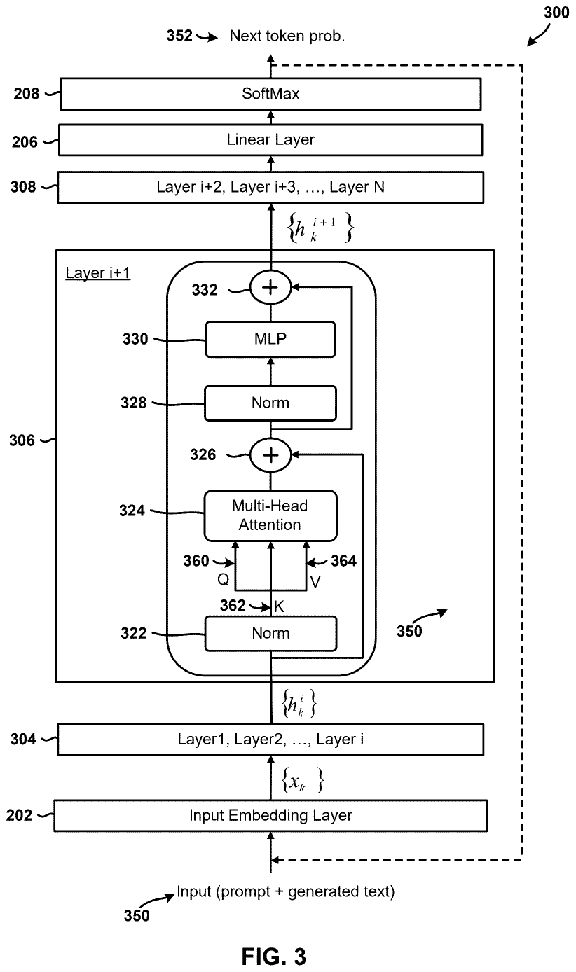

FIG. 3 is a more detailed view of the transformer illustrated and described above with reference to FIG. 2. FIG. 3 illustrates an example in which the transformer model 200 including a decoder-only architecture suitable for processing input sequences to generate predictions (with each component contributing to the overall task of predicting the next token based on previously processed information).

With reference to FIGS. 1-3, the transformer model 200 may include an input embedding layer 202, a first collection of transformer layers 304, one intermediate transformer layer 306, a second collection of transformer layers 308, a linear layer 206, and a softmax 208 component. The intermediate transformer layer 306, and each transformer layer of the first collection of transformer layers 304 and the second collection of transformer layers 308 may include RMS normalization components 322, 328, multi-head attention components 324, a multi-layer perceptron (MLP) component 330, and residual connections 326, 332. These components may work together to refine the hidden state vectors, allowing the model to learn complex dependencies among tokens. For example, data may flow from the input embedding layer 202 through multiple transformer layers 304-308 to a softmax 208 layer component that computes the next token probabilities. The token embeddings may be processed sequentially in layers, with each transformer layer contributing to the refinement of the token representations through components such as multi-head attention 324 and normalization 322, 328. The final layers in the model, including the softmax 208 layer, may process the refined embeddings to generate a probability distribution from which the next token may be sampled.

The input embedding layer 202 may convert received input 350, which may include both prompt tokens and generated text, into input embedding vectors. Prompt tokens may include the initial sequence provided by the user or system, often serving as instructions, a starting context, or the initial data that is input into the transformer processing pipeline. Examples of prompt tokens may include a specific task directive such as “Translate: Bonjour,” a document to summarize, or a phrase to complete. Generated text may include the output tokens that the model has already produced during previous processing. Including previously generated text as part of the received input allows the model to use the most recent output as a new input to continue generating text that is coherent and contextually relevant. In some embodiments, the generated text may include the next token 352 generated by the transformer model 200 as the output of the transformer processing pipeline.

The transformer layers 304 and 308 may each include multiple sequential transformer layers (304 is formed by stacking Layer 1, Layer 2, . . . , Layer i, while 308 is formed by stacking Layer i+2, Layer i+3, . . . , Layer N.), where each layer applies self-attention mechanism, normalization techniques and MLP to the hidden state vectors from the previous layer, corresponding to the input embedding vectors. Each of these layers may progressively transform the input embedding vectors into hidden state vectors that identify or characterize the relationships (e.g., semantic, syntactic, etc.) between tokens in the input sequence.

The intermediate transformer layer 306 and the transformer layers in 304 and 308 may include a multi-head attention 324 component, RMS normalization components 322, 328, MLP components 330, and residual connections (adders) 326, 332. These components 322-332 may work together to refine the hidden state vectors so that the transformer model 200 may learn and understand complex dependencies between tokens.

In the illustrated example, the output of the RMS normalization component 322 is used to generate the Q vector 360, the K vector 362, and the V vector 364. As discussed, the Q, K, and V vectors may allow a transformer model (e.g., 200, 300, etc.) to weigh the significance of different tokens in the sequence based on their contextual relationships.

In some embodiments, the Q, K, and V vectors may be generated or derived in the self-attention layers of the transformer model from the hidden state vectors produced by the previous transformer layer. For example, for the l-th self-attention based transformer layer and the k-th token, the Q, K, and V vectors may be computed as follows:

$${q}_{k}^{l} = Norm ( {h}_{k}^{l - 1} ) {W}_{Q}^{l}$$

$${k}_{k}^{l} = Norm ( {h}_{k}^{l - 1} ) {W}_{K}^{l}$$

$${v}_{k}^{l} = Norm ( {h}_{k}^{l - 1} ) {W}_{V}^{l} ,$$

where Norm( ) denotes normalization operation.

The Q vector

$${q}_{k}^{l}$$

may be generated by applying a linear transformation to the normalized hidden state vector

$${h}_{k}^{l - 1}$$

from the previous layer using a learned projection matrix

$${W}_{Q}^{l}$$

that defines the linear transformation. Similarly, the K vector

$${k}_{k}^{l}$$

and the V vector vₖ^{l} may be generated by applying a linear transformation to the normalized hidden state vector using their respective learned projection matrix (e.g.

$${W}_{K}^{l} , {W}_{V}^{l} ,$$

### etc.). As

$${k}_{k}^{l} and {v}_{k}^{l}$$

are generated, they are stored in KV cache. For example, the keys

$$\{ {k}_{k}^{l} ; l = 1 , 2 , … , N \}$$

and values

$$\{ {v}_{k}^{l} ; l = 1 , 2 , … , N \}$$

corresponding to the 100 prefix tokens (k=0, 1, . . . , 99) are computed and stored in the KV cache, to be used in the sampling of t₁₀₁.

The linear projection matrices

$${W}_{Q}^{l} , {W}_{K}^{l} , and {W}_{V}^{l}$$

may be parameters that are learned during the training process. The hidden state vector

$${h}_{k}^{l}$$

may represent the output of the l-th transformer layer corresponding to the k-th input token tₖ. The hidden state vector

$${h}_{k}^{l}$$

may store the processed information from the previous layer and may integrate the attention-weighted values to form a new representation of the token.

The input embedding xₖ corresponding to the k-th input token may serve as the initial hidden state

$${h}_{k}^{0} .$$

### The set

$$\{ {h}_{k}^{l} \}$$

may denote a set of embeddings from the l layer

$$\{ {h}_{0}^{l} , {h}_{1}^{l} , … \} .$$

The linear layer 206 may transform the final hidden state vectors produced by the last transformer layer into logits, which serve as raw output scores representing the unnormalized probabilities of each possible next token in the sequence. In some embodiments, these operations may include applying a linear function to the final hidden state vectors, effectively mapping the high-dimensional representations of the input sequence into a lower-dimensional space in which each dimension corresponds to a potential next token. The resulting logits identify the model's prediction for the likelihood of each token being the next in the sequence, but they are not yet normalized.

The softmax 208 component may receive and apply the logits to a softmax function to generate a probability distribution. In some embodiments, these operations may include exponentiating each logit and normalizing the results by dividing by the sum of all exponentiated logits to transform the raw output scores into a range of probabilities that sum to one. This probability distribution may rank the likelihood of each token being the next in the sequence. The transformer model 200 may use this probability distribution to sample the most likely next token in the sequence. For example, suppose that the set of 100 tokens (t₀, t₁, . . . , t₉₉) are the prefix tokens in the prompt. To compute the embedding

$${h}_{99}^{N}$$

needed to sample the next token t₁₀₀ as a response to the prompt, all the N transformer layers have to be invoked to obtain the embeddings

$$\{ {h}_{k}^{l} ; l = 1 , 2 , … , N \}$$

for all the 99 prefix tokens (k=0, 1, . . . , 98), which are needed to compute the keys and values needed in the self-attention layers. Hence, the amount of computation is nearly the same as that for generating 101 tokens from scratch, even though 100 tokens are already available.

As discussed, a transformer model may process input embeddings through a series of transformer layers to generate the next token prediction. The input embeddings may be sequentially passed through these layers, with each layer performing specific operations (e.g., multi-head attention, normalization, MLP processing, etc.) to generate the probability distribution for the next token. Since the output of each layer is used as the input for the next layer, the transformer model 200 may be required to perform the computations of all layers before reaching the final layer. For example, the transformer model 200 may be required to compute the hidden state vectors in all preceding layers (from 1 to N−1) before generating the key and value vectors in the final layer N.

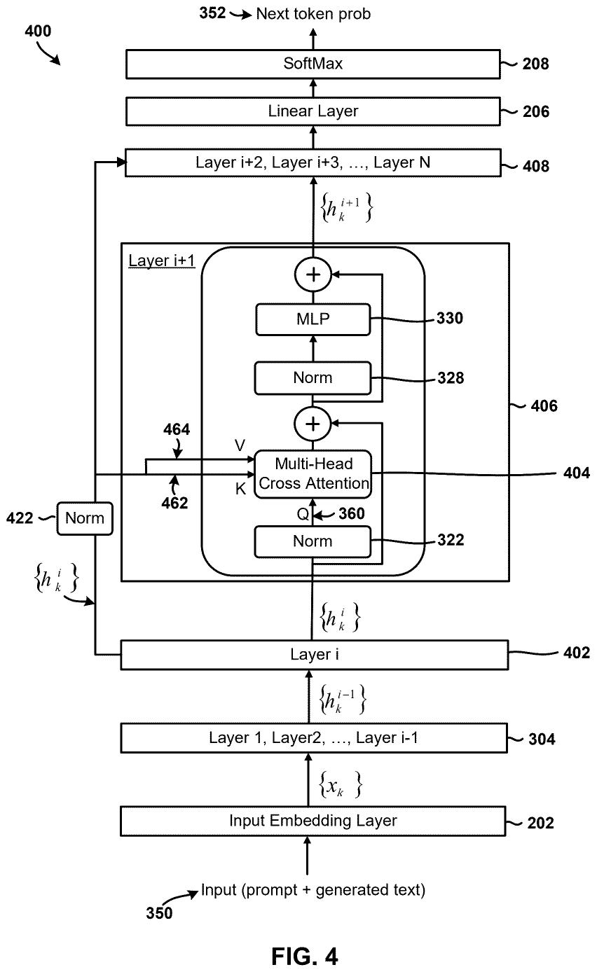

FIG. 4 illustrates an enhanced transformer model 400 that implements and uses KV caching techniques to improve the performance and efficiency of XMs and computing devices that use XMs in accordance with some embodiments. The enhanced transformer model 400 may improve the processing capabilities of the computing device without causing noticeable or user-perceivable performance degradation or increased energy consumption in the device, particularly in LXMs and other applications that process long sequences and for which managing the computational load of self-attention mechanisms are important.

With reference to FIGS. 1-4, the enhanced transformer model 400 may include several components similar to those discussed above with reference to FIGS. 1-3, including an input embedding layer 202, a first collection of transformer layers 304, a linear layer 206, and a softmax 208 layer. The model 400 may also include a cross-attention based transformer layer 406 and a second collection of transformer layers 408. Each layer of the second collection of transformer layers 408 is also a cross-attention based transformer layer. In addition, the enhanced transformer model 400 may include a Layer i 402 (e.g., a transition layer index (i) layer) and integrate a multi-head cross-attention 404 component within the intermediate transformer layer 406 and each layer of 408. The model 400 may include normalization layer 422, which can receive outputs of layer i and provide normalized outputs to multi-head cross attention layer 404 and transformer layers 408.

The input embedding layer 202 may convert input tokens (which may represent words, sub-words, or other data units, etc.) into high-dimensional input embedding vectors. The first collection of transformer layers 304 and the Layer i 402 may apply self-attention mechanisms and perform other operations to progressively refine the input embedding vectors and/or generate the corresponding hidden state vectors that capture the contextual relationships and dependencies among the tokens. In other words, each of the first i layers is a self-attention based transformer layers. The intermediate transformer layer 406 may process these hidden state vectors using the multi-head cross-attention 404, normalization 322, 328, and multi-layer perceptron (MLP) 330 components. The second collection of transformer layers 408 may apply cross-attention mechanisms and perform other operations to progressively refine the hidden state vectors and/or generate the corresponding hidden state vectors that capture the contextual relationships and dependencies among the tokens. (Each of the subsequent N−i layers is a cross-attention based transformer layer.) These operations may allow the enhanced transformer model 400 to learn and understand complex dependencies between tokens.

The multi-head cross-attention 404 may be included in the cross-attention-based transformer layers 406 and 408 and cross-attention mechanisms that allow the enhanced transformer model 400 to align and integrate information from two different sequences. As discussed, in cross-attention mechanisms, the Q vectors 360 are derived from one sequence (e.g., the sequence being processed, etc.) while the key (K) vector 462 and the value (V) vector 464 are derived from another sequence (e.g., from a different input, another network component, etc.). The enhanced transformer model 400 may use the cross-attention mechanism to compare the Q vector with K-V vectors and compute attention scores that determine the relevance of elements in the key-value sequence to the query sequence. The enhanced transformer model 400 may use these scores to weigh the value vectors and combine them into an output that captures and characterizes the contextual information from both sequences.

The enhanced transformer model 400 may store the K-V vectors derived from the transitional output or the final hidden states of the initial transformer layers in memory (e.g., in a KV cache, etc.). These stored K-V vectors may be reused in subsequent layers (e.g., cross-attention-based transformer layers, etc.) to reduce redundant operations. For example, the K and V vectors generated from the i-th layer of self-attention based transformer layers may be directly fed into the multi-head cross-attention 404 mechanisms of subsequent layers. Directly feeding the K and V vectors from the i-th layer into the multi-head cross-attention 404 components of the subsequent layers may significantly reduce the computational workload of the enhanced transformer model 400, which may be particularly beneficial for tasks that include long sequences or those with high computational demands. For example, for the cross-attention based transformer layer, with the transformer layer index l>i, and the k-th token, the Q, K, and V vectors may be computed as follows:

$${q}_{k}^{l} = Norm ( {h}_{k}^{l - 1} ) {W}_{Q}^{l} , {k}_{k}^{l} = Norm ( {h}_{k}^{i} ) {W}_{K}^{l} , and {v}_{k}^{l} = Norm ( {h}_{k}^{i} ) {W}_{V}^{l} .$$

But, for the self-attention based transformer layers with the transformer layer index l≤i, and the k-th token, the Q, K, and V vectors may be computed as follows:

$${q}_{k}^{l} = Norm ( {h}_{k}^{l - 1} ) {W}_{Q}^{l} , {k}_{k}^{l} = Norm ( {h}_{k}^{l - 1} ) {W}_{K}^{l} , and {v}_{k}^{l} = Norm ( {h}_{k}^{l - 1} ) {W}_{V}^{l} .$$

Notice that for l>i,

$${k}_{k}^{l} and {v}_{k}^{l}$$

can be computed without computing

$${h}_{k}^{l - 1} .$$

Otherwise, it may be necessary to run the entire decoder to compute the keys and values from the prefix tokens in the prompt during the prefilling stage.

The linear layer 206 may receive the final hidden state vectors, transform them into logits, and send the logits to the second collection of transformer layers 408 or the softmax layer 208. The softmax layer 208 may convert the logits into a probability distribution that identifies the likelihood of each possible next token. The enhanced transformer model 400 may use or sample the probability distribution to identify and select the most probable token to continue the sequence generation. The transformer model 400 may iteratively perform these operations to generate data sequences that are coherent and contextually relevant.

By implementing KV caching to store and reuse K-V vectors from transitional output or final hidden states, and by using cross-attention mechanisms, the enhanced transformer model 400 may significantly enhance its ability to process long sequences and manage high computational demands. This improvement may result in better efficiency, processing speed, and power consumption characteristics. As such, the enhanced transformer model 400 may be suitable for deployment in both high-performance computing environments and resource-constrained computing devices.

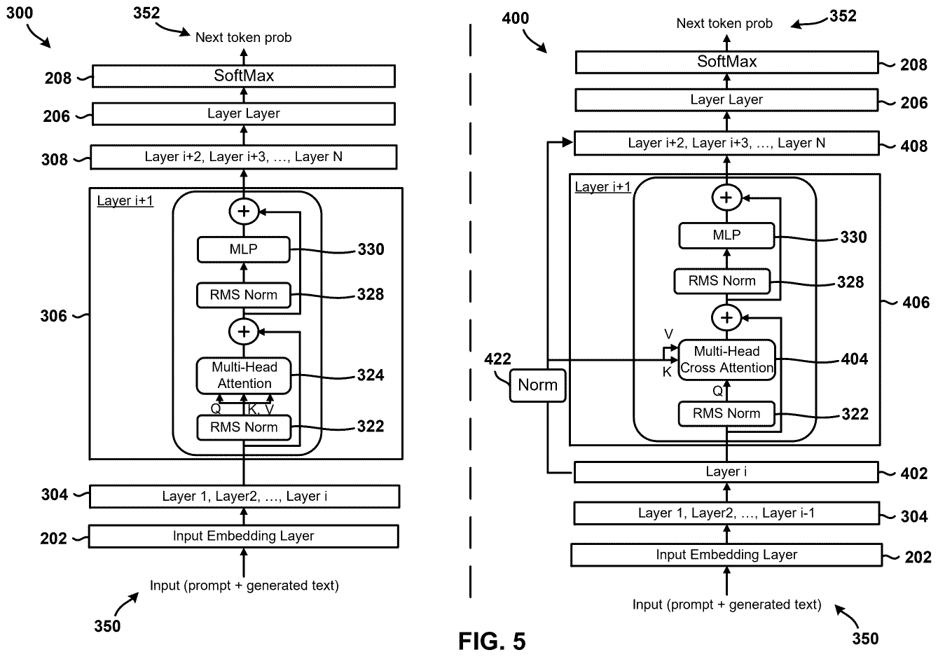

FIG. 5 illustrates a side-by-side comparison of two transformer models, 300 and 400, discussed above. The models 300 and 400 may sequentially process input data through multiple layers, with each layer refining the data to generate the next token in the sequence. While the fundamental operations in models 300 and 400 are similar, there are important differences in how each model manages long sequences of input data.

The transformer model 300 includes a configuration in which each layer processes the entire sequence to progressively generate hidden state vectors and refine the representation of the input tokens. The computational demands of the transformer model 300 grow as the sequence length increases.

By contrast, the enhanced transformer model 400 includes an enhanced configuration that uses key-value (KV) caching. The enhanced transformer model 400 improves the processing of long sequences by computing and storing the key (K) and value (V) vectors derived from the final hidden states of the initial transformer layers in memory. These cached vectors may be reused in subsequent layers (e.g., within the multi-head cross-attention components of intermediate layers, such as the multi-head cross-attention 404, etc. and the cross-attention based transformer layers in 408.) to reduce redundant computations. As a result, the enhanced transformer model 400 may improve computational efficiency, reduce power consumption, and shorten processing times.

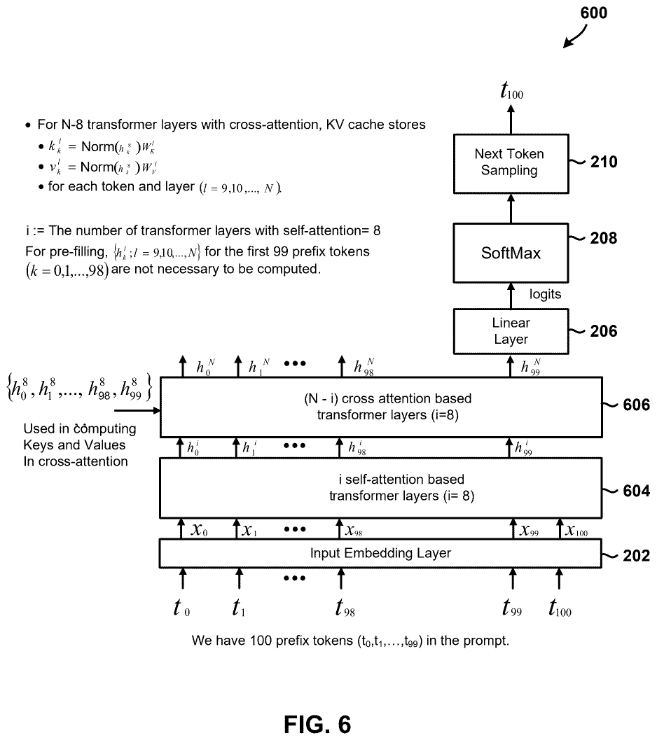

FIG. 6 illustrates the enhanced transformer model 400 (discussed above with reference to FIG. 4) at a different level of abstraction. With reference to FIGS. 1-6, the enhanced transformer model 400 may include a sequential data processing pipeline that includes an input embedding layer 202, two sets of transformer layers (self-attention 604 and cross-attention 606), a linear layer 206, a softmax layer 208, and a next token sampling component 210.

In the example illustrated in FIG. 6, enhanced transformer model avoids computing hidden state vectors for the first 99 prefix tokens (i.e., t₀, t₁, . . . , t₉₈) beyond the i self-attention based transformer layers, where i=8. (Recall that i denotes the number of self-attention based transformer layers.) Specifically, hidden state vectors for layers 9 through N (i.e.,

$${h}_{k}^{l}$$

for l=9, 10, . . . , N) are not computed for the first 99 prefix tokens. Instead, the model directly uses the transitional output vectors from the 8 self-attention based transformer layers

$$( {h}_{0}^{8} , {h}_{1}^{8} , … , {h}_{99}^{8} )$$

to compute the key and value vectors in the cross-attention layers in 606. Various embodiment may provide efficient prefilling by using the transitional output from the 8th self-attention based transformer layer in the cross-attention layers in 606. This enables the model to significantly reduce redundant calculations for the key and value vectors corresponding to the prefix tokens in the input prompt, which may be necessary for autoregressive generation of new tokens in response to the prefix tokens. As a result, the time to generate the first token (TTFT) may be significantly smaller than the TTFT of the prior art illustrated in FIG. 2 and FIG. 3. Further, the hidden state vectors for layers 9 through N (i.e.,

$${h}_{k}^{l}$$

for l=9, 10, . . . , N) and the corresponding logits vectors for the first 99 tokens are not realized in memory in the prefilling stage, which significantly reduce memory consumption footprint. This approach saves both time and computational resources, making the model more suitable for processing long input context, i.e. prompt, or operating in resource-constrained environments. These improvements may be particularly beneficial during the prefilling stage in the split computing setting, where some of the processing is done in the local client device such as a mobile phone, and the rest is done by the server in the cloud. The number of self-attention based transformer layers given by i can be determined by a local client device which receives the user prompt. The determined number of self-attention based transformer layers, i, is sent to the server, along with the user prompt, which can reduce the work load on the server during the prefilling stage, which can help increase the number of clients that it can serve.

The input embedding layer 202 may receive input tokens, which may include discrete units of information such as words, sub-words, or other data elements in a sequence (t₀, t₁, . . . , t₉₉, t₁₀₀). In this example, the first 100 tokens (t₀, t₁, . . . , t₉₉) are the prefix tokens, and t₁₀₀ is a newly generated token in response to the prefix tokens in the input prompt. The input embedding layer 202 may convert each input token into a corresponding embedding vector (xₖ) in which k denotes the position of the token in the sequence. The input embedding vectors (x₀, x₁, . . . , x₉₉, x₁₀₀) may be continuous vector representations that encode the semantic and syntactic information of the tokens within a high-dimensional space. These embeddings may serve as the initial or foundational inputs for the subsequent transformer layers, allowing the model to process and understand the relationships between tokens based on their vectorized representations.

The self-attention component 604 may include multiple (e.g., i=8, etc.) self-attention based transformer layers that process the sequence of embedding vectors (x₀, x₁, . . . , x₉₉, x₁₀₀) generated by the input embedding layer 202. Each self-attention transformer layer may apply self-attention mechanisms to the sequence of embedding vectors to compute hidden state vectors

$$( \{ {h}_{0}^{l} , {h}_{1}^{l} , … , {h}_{99}^{l} , {h}_{100}^{l} \}$$

for l=1, 2, . . . , i, where i=8). The self-attention mechanisms may allow the model to dynamically weigh the importance of each token relative to others within the sequence, thereby capturing the contextual relationships and dependencies among the tokens. These operations may be repeated across all the layers (e.g., all i=8 layers, etc.), with each layer progressively refining the hidden state vectors to generate more abstract representations of the input sequence that are more informative for subsequent processing stages. Thus, as the sequence passes through each layer, the hidden state vectors are progressively refined, enabling the generation of more abstract and informative representations of the input sequence for further processing.

The cross-attention component 606 may include (N−i) cross-attention based transformer layers with cross-attention mechanisms that build upon the hidden state vectors produced by the self-attention component 604. The cross-attention based transformer layers may execute after the self-attention component 604 to build upon the refined hidden state vectors

$$( \{ {h}_{0}^{i} , {h}_{1}^{i} , … , {h}_{99}^{i} , {h}_{100}^{i} \}$$

for i=8) generated by the last layer in the self-attention component 604. These cross-attention transformer layers may further process the hidden state vectors

$$( {h}_{0}^{i} , {h}_{1}^{i} , … , {h}_{99}^{i} , {h}_{100}^{i} )$$

through mechanisms that integrate and align information from different sequences or sources. In cross-attention at the l-th transformer layer with l>i, the model derives the query (Q) vectors from the sequence being processed, e.g., the hidden state vectors

$$( {h}_{0}^{l - 1} , {h}_{1}^{l - 1} , … , {h}_{99}^{l - 1} , {h}_{100}^{l - 1} ) .$$

In contrast, the key (K) and value (V) vectors are derived from another sequence or the output of another network component, e.g., the hidden state vectors

$$( {h}_{0}^{i} , {h}_{1}^{i} , … , {h}_{99}^{i} , {h}_{100}^{i} ) .$$

The cross-attention mechanism may compare the Q vectors with the K-V pairs to compute attention scores, which may be used to weight the V vectors and produce contextually relevant outputs. The final output of the cross-attention component 606 may be a collection of hidden state vectors

$$( {h}_{0}^{N} , {h}_{1}^{N} , … , {h}_{99}^{N} , {h}_{100}^{N} )$$

that encapsulate information from both sequences and serve as inputs for the subsequent linear layer.

The linear layer 206 may receive the final cross-attention based hidden state vectors

$$( {h}_{0}^{N} , {h}_{1}^{N} , … , {h}_{99}^{N} , {h}_{100}^{N} )$$

produced by the cross-attention based transformer layers. The linear layer 206 may apply a linear transformation to these hidden state vectors to generate logits (i.e., raw output scores that represent the unnormalized probabilities of each possible next token in the sequence, which may be converted into a probability distribution by the softmax layer). These linear transformations may help ensure that the hidden state vectors are mapped to a lower-dimensional space in which each dimension corresponds to a possible next token.

The softmax layer 208 may provide a probabilistic framework from which the most likely next token may be selected. For example, the softmax layer 208 component may take the logits produced by the linear layer 206 and convert them into a probability distribution. This conversion may be performed using the softmax function, which exponentiates each logit and normalizes the results by dividing by the sum of all exponentiated logits. The output of the softmax layer may be a probability distribution value or information structure in which each value represents the likelihood that a specific token will be the next in the sequence.

The next token sampling component 210 may use the probability distribution generated by the softmax layer 208 to sample or select the next token in the sequence. The next token sampling component 210 may identify the token with the highest probability or apply a sampling method to choose the next token (t₁₀₀). The selected token may be added to the sequence of previously generated tokens. The model may repeat the above operations using the updated sequence as input to generate further tokens in an autoregressive manner and continue generating tokens until a complete sequence is formed.

The enhanced transformer model 400 may reduce redundant computations by using KV caching in the cross-attention transformer layers to store and reuse key and value vectors derived from earlier layers. The model 400 may be configured to operate such that the computations of hidden state vectors for the prefix tokens in layers beyond the last self-attention based transformer layer (i=8) are avoided. The model 400 may derive the key

$$( {k}_{k}^{l} )$$

and value

$$( {v}_{k}^{l} )$$

vectors used by the cross-attention layers in the cross-attention based transformer layers (l=9, 10, . . . , N.) in the cross-attention component 606 directly from the normalized hidden state vectors

$${h}_{k}^{8}$$

of the final self-attention based transformer layer in the self-attention component 604. This may be achieved by applying linear projections using the learned projection matrices

$${W}_{K}^{l} and {W}_{V}^{l}$$

to the normalized hidden state vectors. More specifically,

$${k}_{k}^{l} = Norm ( {h}_{k}^{i} ) {W}_{K}^{l} , and {v}_{k}^{l} = Norm ( {h}_{k}^{i} ) {W}_{V}^{l}$$

for i=8, and l=9, 10, . . . , N.

The enhanced transformer model 400 may also improve memory usage. For example, model 400 may improve memory usage by storing only the hidden state vectors

$${h}_{k}^{8}$$

from the last self-attention based transformer layer in the KV cache (as opposed to storing all key and value vectors for the cross-attention layers). In other words, the KV cache will only store the vectors

$${h}_{k}^{8} ,$$

in addition to all key and value vectors computed from the self-attention based transformer layers. Since the key

$$( {k}_{k}^{l} )$$

and value

$$( {v}_{k}^{l} )$$

vectors may be readily recomputed from these stored hidden state vectors through linear projections, significantly reducing the amount of memory associated with the KV cache at the expense of increasing the amount of computation incurred by linear projections. This tradeoff between memory usage and computational load may be particularly effective when the number of output tokens is much smaller than the number of input tokens in the prompt, as the model can readily recompute the KV vectors for the cross-attention layers.

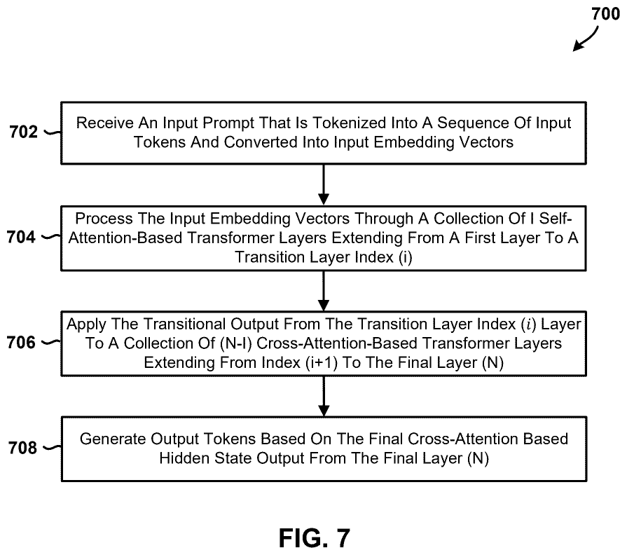

FIGS. 7-10 are process flow diagrams illustrating methods 700, 800, 900, 1000 of improving operation of a computing device executing a generative model (XM) in accordance with various embodiments. With reference to FIGS. 1-10, the methods 700, 800, 900, 1000 may be performed in a computing device by at least one processor encompassing one or more processors (e.g., 110, 112, 114, 116, 118, 121, 122, 121, 122, 152, 160, etc.), components or subsystems discussed in this application. Means for performing the functions of the operations in the methods 700, 800, 900, 1000 may include at least one processor including one or more of processors 110, 112, 114, 116, 118, 121, 122, 121, 122, 152, 160, and other components described herein. Further, one or more processors of at least one processor may be configured with software or firmware to perform some or all of the operations of the methods 700, 800, 900, 1000. In order to encompass the alternative configurations enabled in various embodiments, the hardware implementing any or all of the methods 700, 800, 900, 1000 is referred to herein as a “processor,” “processing system,” or “at least one processor.”

Referring to FIG. 7, and with reference to FIGS. 1-6, in block 702, the processing system may receive an input prompt that is tokenized into a sequence of input tokens and converted into input embedding vectors. For example, the processing system may receive raw input from the user, preprocess the received input (e.g., by lowercasing, removing punctuation, handling special characters, etc.), and then perform tokenization operations to break down the preprocessed text into tokens. The resulting sequence of input tokens may be passed through an embedding layer that maps each token to a high-dimensional input embedding vector that encodes various attributes and relationships within the token.

In block 704, the processing system may process the input embedding vectors through a collection of i self-attention-based transformer layers extending from a first layer to a transition layer index (i). For example, the processing system may sequentially apply self-attention mechanisms within each transformer layer to dynamically evaluate the relationships and dependencies among the tokens in the sequence.

In each self-attention-based transformer layer, the processing system may compute attention scores that determine how much focus should be placed on different tokens relative to one another. As the input embedding vectors pass through these layers, the processing system may progressively refine them, generating increasingly abstract and informative hidden state vectors at each layer. These hidden state vectors may represent the evolving understanding of the input data as the model processes the data. The transition layer index (i) may represent the point in the model at which the processing shifts from self-attention mechanisms to cross-attention mechanisms or another set of operations to further refine or use the information captured in the initial layers.

In some embodiments, processing the input embedding vectors through a collection of i self-attention-based transformer layers extending from a first layer to a transition layer index (i) in block 704 may include computing query (Q), key (K), and value (V) vectors for each input hidden state vector, where the input embedding vector becomes the input hidden state vector for the first self-attention-based transformer layer, and the output hidden state vector of the preceding layer becomes the input hidden state vector for the remaining self-attention-based transformer layers, performing self-attention computations using the computed Q, K, V vectors, applying normalization and a MLP to the self-attention output, and generating a hidden state for each layer in the collection of self-attention-based transformer layers.

In block 706, the processing system may apply the transitional output from the transition layer index (i) layer to a collection of (N−i) cross-attention-based transformer layers extending from index (i+1) to the final layer (N). For example, the processing system may use the cross-attention-based transformer layers to integrate and align information from different sequences or sources. The cross-attention layers may process the hidden state vectors by comparing them to key and value vectors derived from another sequence or component within the model. This comparison may generate attention scores, which may be used to determine weights for the value vectors and produce contextually relevant outputs. The final output of the cross-attention-based transformer layers may be a collection of hidden state vectors that encapsulate the combined information from multiple sequences that may be used as input for subsequent layers.

In some embodiments, applying the transitional output from the transition layer index (i) layer to the collection of (N−i) cross-attention-based transformer layers extending from the index (i+1) to the number of layers (N) in block 706 may include determining a query (Q) vector from the previous transformer layer's output, determining a key (K) vector and a value (V) vector from the transitional output from the transition layer index (i) layer, performing cross-attention computations using the Q vector, the K vector, and the V vector, applying normalization and a MLP to the cross-attention output, and generating a hidden state for each layer in the collection of (N−i) cross-attention-based transformer layers.

In block 708, the processing system may generate output tokens based on the final cross-attention based hidden state output from the final layer (N). For example, the processing system may apply a linear transformation to the cross-attention hidden state vectors to produce logits, which represent unnormalized scores for each possible token in the vocabulary. The logits may be passed through a softmax function to convert them into a probability distribution in which each token in the vocabulary is assigned a likelihood of being the next token in the sequence. Based on this probability distribution, the processing system may select the token with the highest probability (e.g., greedy sampling) or use a more probabilistic method (e.g., stochastic sampling, top-k sampling, or top-p sampling) to choose the next token. The selected token may be appended to the sequence. The processing system may iteratively repeat these operations until a complete sequence of output tokens is generated.

In some embodiments, generating the output tokens based on the final cross-attention based hidden state output from the final layer in the number of layers (N) in block 708 may include computing final output token probabilities using the final cross-attention based hidden state output from the final layer, applying a softmax function to obtain a probability distribution over a vocabulary, and sampling an output token from the probability distribution.

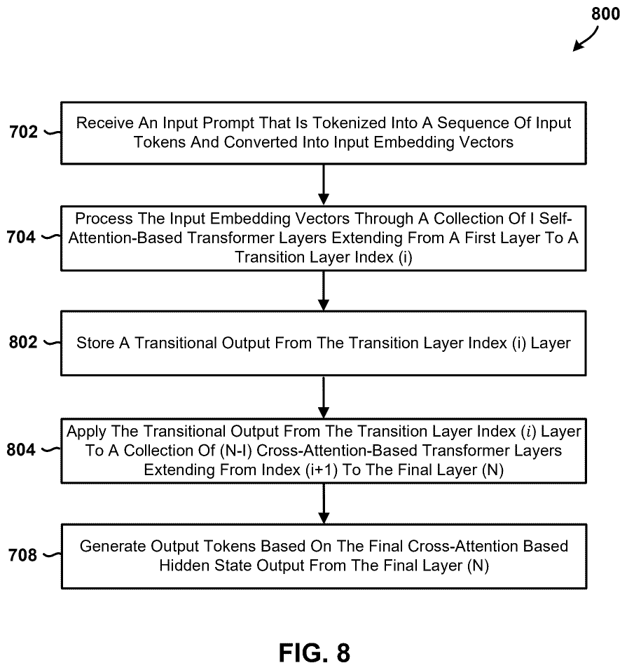

Referring to FIG. 8, and with reference to FIGS. 1-7, in blocks 702 and 704, the processing system may perform the operations of the like-numbered blocks of the method 700 as described.

In block 802, the processing system may store a transitional output from the transition layer index (i) layer in addition to all key and value vectors computed from the i self-attention based transformer layers. In some embodiments, storing the transitional output in block 802 may include storing the hidden state output from the last self-attention-based transformer layer before the AI model transitions to using cross-attention-based transformer layers.

For example, the processing system may store the transitional output from the transition layer index (i) layer in a dedicated memory buffer or KV cache that allows for efficient retrieval during subsequent processing stages. The processing system may organize the stored transitional output based on the sequence position of each input token and the specific transition layer index (i) so that the stored hidden state vectors may be quickly accessed during later computations. The stored transitional output may be used when generating key and value vectors in cross-attention-based transformer layers or when revisiting and refining the context of the input sequence to generate the final output tokens. By storing the transitional output, the processing system may reduce redundant computations, thereby conserving computational resources and improving processing efficiency.

In block 804, the processing system may apply the transitional output from the transition layer index (i) layer to a collection of (N−i) cross-attention-based transformer layers extending from index (i+1) to the final layer (N).

In block 708, the processing system may perform the operations of the like-numbered blocks of the method 700 as described.

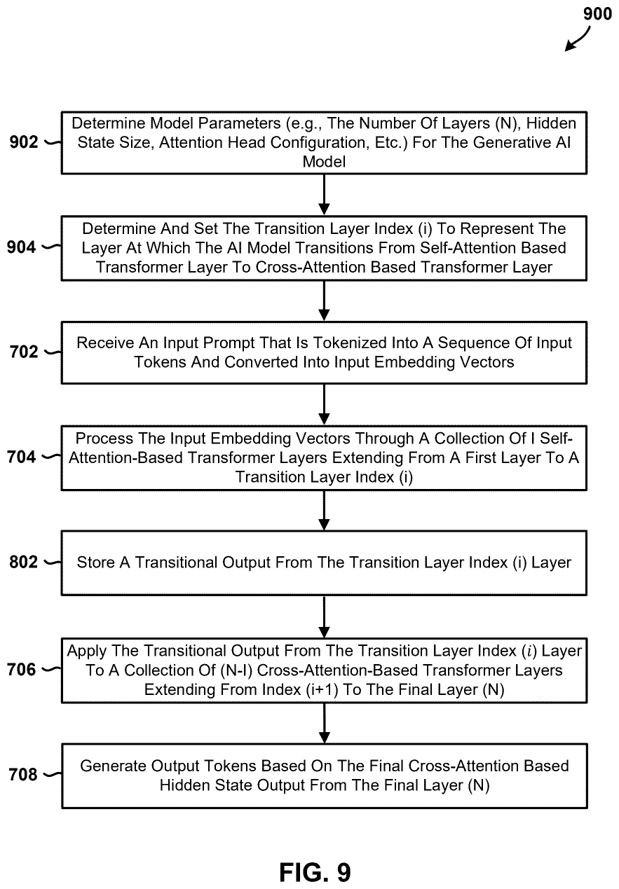

Referring to FIG. 9, and with reference to FIGS. 1-8, in block 902, the processing system may determine model parameters (e.g., the number of layers (N), hidden state size, attention head configuration, etc.) for the generative AI model. For example, the processing system may analyze the specific requirements of the task, such as the complexity of the input tokens, the desired accuracy of the output tokens, and the computational resources available. In some embodiments, the processing system may select an appropriate number of layers (N) to balance model depth and computational efficiency so that the model captures the necessary hierarchical patterns without excessive overfitting or resource consumption. In some embodiments, the processing system may determine the hidden state size based on the requirements for robust and detailed embedding vectors and adjust the dimensionality to capture the semantic and syntactic nuances encoded within the tokens.

In some embodiments, the processing system may configure the attention head settings by evaluating the need for parallel self-attention mechanisms that capture multiple aspects of the input tokens simultaneously, determining the number of attention heads to enhance the model's ability to focus on different parts of the sequence without overwhelming the system's processing capacity. In some embodiments, determining model parameters may include iterative experimentation in which the processing system tests various configurations, monitors performance metrics, and refines the settings to achieve the optimal balance between accuracy, efficiency, and resource management for the specific generative task.

In block 904, the processing system may determine and set the transition layer index (i) to represent the layer at which the AI model transitions from self-attention based transformer layer to cross-attention based transformer layer. For example, the processing system may evaluate the complexity and length of the input token sequence or the specific requirements of the task the AI model is designed to perform. The processing system may analyze the sequence to determine how many self-attention-based transformer layers are necessary to fully capture the internal relationships among the tokens before integrating external context through cross-attention-based transformer layers. Based on this analysis, the processing system may set the transition layer index (i) at a point that balances the need for thorough self-attention processing with the need to incorporate external context through cross-attention mechanisms. The processing system may consider resource constraints and efficiency requirements and adjust the transition layer index (i) to improve model performance and reduce computational costs. In some embodiments, this determination may include empirical testing and performance evaluation to fine-tune the transition layer index (i) so that the AI model achieves the desired balance between capturing internal dependencies and integrating external information.

In blocks 702, 704, 802, 706, and 708, the processing system may perform the operations of the like-numbered blocks of the method 700 as described.

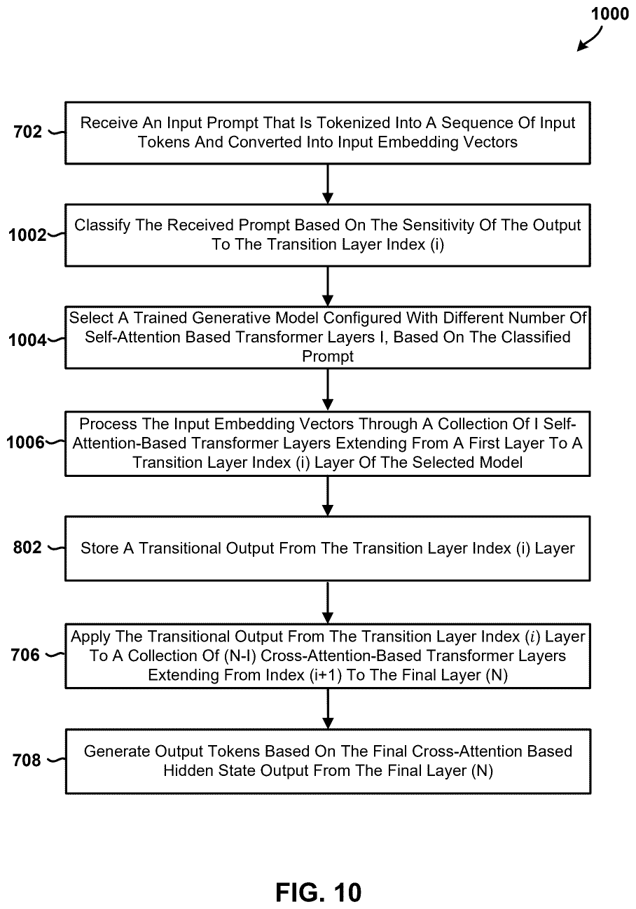

Referring to FIG. 10, and with reference to FIGS. 1-9, in block 702, the processing system may perform the operations of the like-numbered block of the method 700 as described.

In block 1002, the processing system may classify the received prompt based on the sensitivity of the output to the transition layer index (i). (The index i denotes the number of self-attention based transformer layers. For example, if there are 8 self-attention based transformer layers, i=8). For example, the processor may analyze the prompt to determine how variations in the transition layer index (i) could impact the quality or relevance of the generated output. The processor may evaluate factors such as the complexity of the prompt, the length of the input sequence, and the required contextual depth. For more straightforward prompts in which the transition layer index (i) does not significantly affect output quality, the processor may classify the prompt as low sensitivity, and hence a small value for i is chosen for generation, for example i=1 On the other hand, for more complex or context-dependent prompts in which the transition layer index (i) significantly affects the output, the processor may classify the prompt as high sensitivity, and hence a large value for i is chosen for generation, for example i=8. The processor may use the classification to adjust the AI model's configuration and set the transition layer index (i) appropriately based on the sensitivity classification.

In block 1004, the processing system may select a trained generative model configured with different number of self-attention based transformer layers i, based on the classified prompt. For example, the processor may analyze the prompt to determine its complexity, length, and the level of contextual integration, and use the analysis results to identify and select a suitable generative model from a collection of pre-trained models, each of which includes different number of self-attention based transformer layers given by i that correspond to different tradeoffs between self-attention and cross-attention mechanisms.

The processor may select a generative model with a higher value for index i in response to determining that the prompt is classified as requiring a deep understanding of contextual relationships and integration across multiple sequences (e.g., a prompt requiring detailed explanations or handling multiple topics). The selected model may allow the processing system to transition later to cross-attention layers to more effectively align and integrate information from different contexts. Alternatively, for prompts that are straightforward or involve relatively short sequences, the processing system may select a model with a lower value for transition layer index (i) (for example, i=1) that allows the processing system to focus less on refining the relationships within the input sequence through self-attention before transitioning to cross-attention.

In block 1006, the processing system may process the input embedding vectors through a collection of i self-attention-based transformer layers extending from a first layer to a transition layer index (i) layer of the selected model. For example, the processing system may sequentially apply self-attention mechanisms within each transformer layer to dynamically evaluate and refine the relationships and dependencies among the input tokens, compute attention scores in each self-attention layer, determine the relative importance of each token in the sequence, and/or otherwise perform the operations of block 704 as described.

In blocks 802, 706, and 708, the processing system may perform the operations of the like-numbered blocks of the methods 700 and 800 as described.

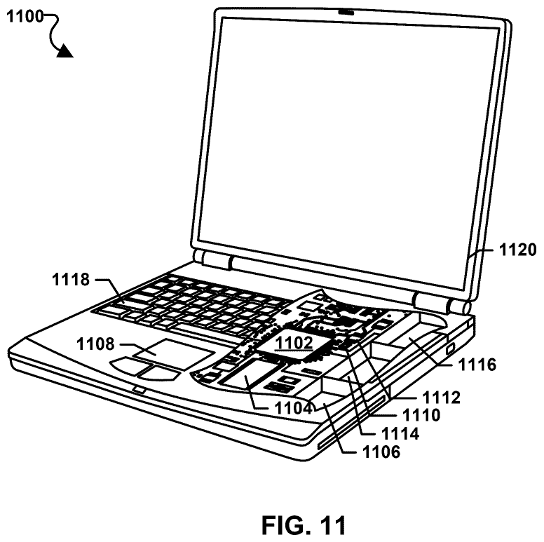

In some examples, the processes described herein (e.g., process 700, 800, 900, 1000 and/or other process described herein) may be performed by a computing device or apparatus or a component or system (e.g., one or more chipsets, one or more processors such as one or more CPUs, DSPs, NPUs, NSPs, microcontrollers, ASICs, FPGAs, programmable logic devices, discrete gates or transistor logic components, discrete hardware components, etc., an ML system such as a neural network model, any combination thereof, and/or other component or system) of the computing device or apparatus. The computing device or apparatus may be a vehicle or component or system of a vehicle, a mobile device (e.g., a mobile phone), a network-connected wearable such as a watch, an extended reality (XR) device (e.g., a virtual reality (VR) device, augmented reality (AR) device, and/or mixed reality (MR) device), or other type of computing device. In some cases, the computing device or apparatus can be the include a computer 1100, an example of which is illustrated in FIG. 11.

FIG. 11 is a component block diagram illustrating an example computing system 1100 suitable for implementing some embodiments. Computing system 1100 may include a processor 1102 of a processing system coupled to volatile memory 1104 and a large capacity nonvolatile memory, such as a disk drive 1106 of Flash memory. The computer 1100 may include a touchpad touch surface 1108 that serves as the computer's pointing device, and thus may receive drag, scroll, and flick gestures. Additionally, the computer 1100 may have one or more antenna 1110 for sending and receiving electromagnetic radiation that may be connected to a wireless data link and/or cellular telephone transceiver 1112 coupled to the processor 1102. The computer 1100 may also include a BT transceiver 1114, a compact disc (CD) drive 1116, a keyboard 1118, and a display 1120 all coupled to the processor 1102. Other configurations of the computing device may include a computer mouse or trackball coupled to the processor (e.g., via a universal serial bus (USB) input) as are well known, which may also be used in conjunction with various embodiments.

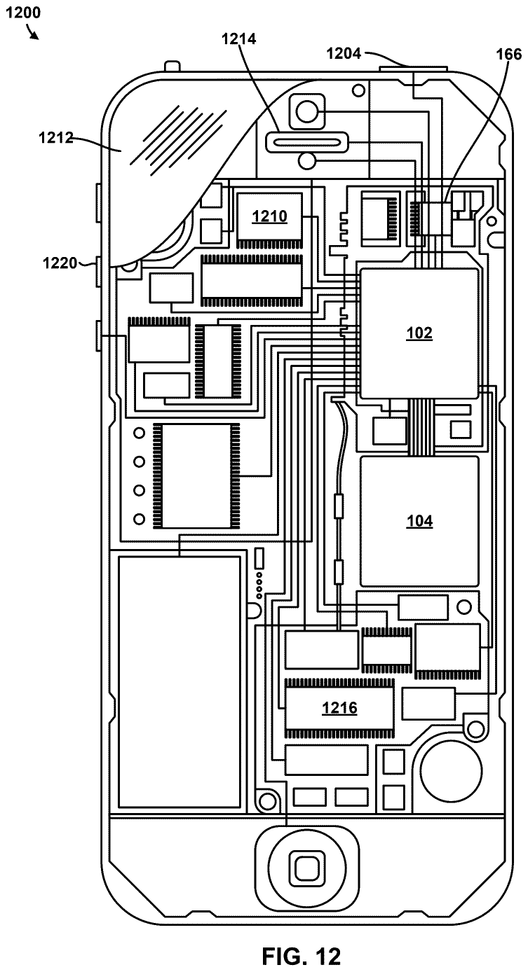

FIG. 12 is a component block diagram of a computing device 1200 suitable for use with various embodiments. With reference to FIGS. 1-12, various embodiments may be implemented on a variety of computing devices 1200, an example of which is illustrated in FIG. 12 in the form of a smartphone. The computing device 1200 may include a first SOC 102 of a processing system coupled to a second SOC 104 of the processing system. The first and second SoCs 102, 104 may be coupled to internal memory 1216, a display 1212, and to a speaker 1214. The first and second SOCs 102, 104 may also be coupled to at least one subscriber identity module (SIM) 1240 and/or a SIM interface that may store information supporting a first 5GNR subscription and a second 5GNR subscription, which support service on a 5G non-standalone (NSA) network.

The computing device 1200 may include an antenna 1204 for sending and receiving electromagnetic radiation that may be connected to a wireless transceiver 166 coupled to one or more processors in the first and/or second SOCs 102, 104. The computing device 1200 may also include menu selection buttons or rocker switches 1220 for receiving user inputs.

The computing device 1200 also includes a sound encoding/decoding (CODEC) circuit 1210, which digitizes sound received from a microphone into data packets suitable for wireless transmission and decodes received sound data packets to generate analog signals that are provided to the speaker to generate sound. Also, one or more of the processors in the first and second SOCs 102, 104, wireless transceiver 166 and CODEC 1210 may include a digital signal processor (DSP) circuit (not shown separately).

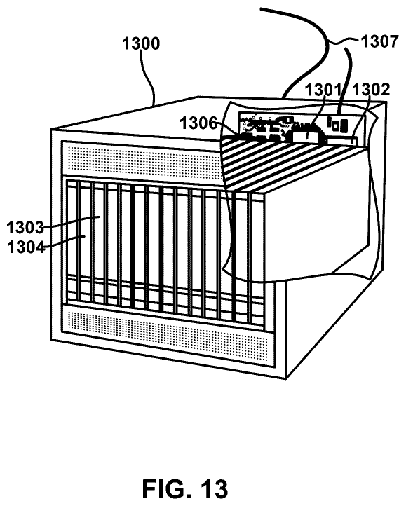

Some embodiments may be implemented on any of a variety of commercially available computing devices, such as the server computing device 1300 illustrated in FIG. 13. Such a server device 1300 may include a processor 1301 of a processing system coupled to volatile memory 1302 and a large capacity nonvolatile memory, such as a disk drive 1303. The server device 1300 may also include a floppy disc drive, USB, etc. coupled to the processor 1301. The server device 1300 may also include network access ports 1306 coupled to the processor 1301 for establishing data connections with a network connection circuit 1304 and a communication network 1307 (e.g., an Internet protocol (IP) network) coupled to other communication system network elements.

The processors or processing units discussed in this application may be any programmable microprocessor, microcomputer, or multiple processor chip or chips that can be configured by software instructions (applications) to perform a variety of functions, including the functions of various embodiments described. In some computing devices, multiple processors may be provided, such as one processor within first circuitry dedicated to wireless communication functions and one processor within a second circuitry dedicated to running other applications. Software applications may be stored in the memory before they are accessed and loaded into the processor. The processors may include internal memory sufficient to store the application software instructions.

Implementation examples are described in the following paragraphs. While some of the following implementation examples are described in terms of example methods, further example implementations may include: the example methods discussed in the following paragraphs implemented by a computing device including at least one processor coupled to memory and configured (e.g., with processor-executable instructions) to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.
Aspect 1. A method of improving operation of a computing system executing a generative model, comprising: receiving an input prompt that is tokenized into a sequence of input tokens and converted into input embedding vectors; processing the input embedding vectors through a collection of self-attention-based transformer layers extending from a first layer to a transition layer index ( ); storing a final self-attention based hidden state output from the transition layer index (i) layer; applying the final self-attention based hidden state output to a collection of cross-attention-based transformer layers, where N is a number of layers, extending from the transition layer index (+1) to the number of layers to generate a final cross-attention based hidden state output; and generating output tokens based on the final cross-attention based hidden state output from the final layer in the number of layers (N).
Aspect 2. The method of aspect 1, further comprising: determining model parameters for the generative model, wherein the model parameters include one or more of a number of layers (N), a hidden state size, or an attention head configuration; and setting the transition layer index ( ) to represent a layer at which the generative model transitions from self-attention based transformer layer to cross-attention based transformer layer.
Aspect 3. The method of aspects 1-2, further comprising: classifying the received input prompt based on sensitivity of the output to index; and selecting one of a plurality of trained generative model models configured with different index values based on the classified received prompt, wherein processing the input prompt is performed using the selected one of the plurality of trained generative models.
Aspect 4. The method of aspects 1-3, wherein processing the input embedding vectors through a collection of self-attention-based transformer layers extending from a first layer to a transition layer index ( ) comprises: computing query (Q), key (K), and value (V) vectors corresponding to each input hidden state vector, where the input hidden state vectors are the output hidden state vectors of a preceding self-attention-based transformer layer or the input embedding vectors; performing self-attention computations using the computed Q, K, V vectors; applying normalization and a multi-level perceptron (MLP) to the self-attention output; and generating a collection of one or more output hidden state vectors for each layer in the collection of self-attention-based transformer layers.
Aspect 5. The method of aspects 1-4, wherein storing the final self-attention based hidden state output comprises storing a hidden state output from a last self-attention-based transformer layer before the generative model transitions to using cross-attention-based transformer layers.
Aspect 6. The method of aspects 1-5, wherein applying the final self-attention based hidden state output to the collection of) cross-attention-based transformer layers extending from the transition layer index (+1) to the number of layers (N) comprises: determining a query (Q) vector from an output of a previous layer; determining a key (K) vector and a value (V) vector from the final self-attention based hidden state output; performing cross-attention computations using the Q vector, the K vector, and the V vector to generate a cross-attention output; applying normalization and a multi-level perceptron (MLP) to the cross-attention output; and generating a hidden state for each layer in the collection of cross-attention-based transformer layers.
Aspect 7. The method of aspects 1-6, wherein generating the output tokens based on the final cross-attention based hidden state output from the final layer in the number of layers (N) comprises: computing final output token probabilities using the final cross-attention based hidden state output from the final cross-attention based transformer layer; applying a softmax function to obtain a probability distribution over a vocabulary; and sampling an output token from the probability distribution.
Aspect 8. An apparatus for improving operation of a computing system executing a generative model, comprising: at least one memory comprising instructions; and at least one processor coupled to the at least one memory and configured to perform operations comprising: receiving an input prompt that is tokenized into a sequence of input tokens and converted into input embedding vectors; processing the input embedding vectors through a collection of self-attention-based transformer layers extending from a first layer to a transition layer index ( ); storing a final self-attention based hidden state output from the transition layer index (i) layer; applying the final self-attention based hidden state output to a collection of cross-attention-based transformer layers, where N is a number of layers, extending from the transition layer index (+1) to the number of layers to generate a final cross-attention based hidden state output; and generating output tokens based on the final cross-attention based hidden state output from the final layer in the number of layers (N).
Aspect 9. The apparatus of aspect 8, wherein the processor is further configured to perform operations comprising: determining model parameters for the generative model, wherein the model parameters include one or more of a number of layers (N), a hidden state size, or an attention head configuration; and setting the transition layer index ( ) to represent a layer at which the generative model transitions from self-attention based transformer layer to cross-attention based transformer layer.
Aspect 10. The apparatus of aspects 8-9, wherein the processor is further configured to perform operations comprising: classifying the received input prompt based on sensitivity of the output to index; and selecting one of a plurality of trained generative model models configured with different index values based on the classified received prompt, wherein processing the input prompt is performed using the selected one of the plurality of trained generative models.
Aspect 11. The apparatus of aspects 8-10, wherein processing the input embedding vectors through a collection of self-attention-based transformer layers extending from a first layer to a transition layer index ( ) comprises: computing query (Q), key (K), and value (V) vectors corresponding to each input hidden state vector, where the input hidden state vectors are the output hidden state vectors of a preceding self-attention-based transformer layer or the input embedding vectors; performing self-attention computations using the computed Q, K, V vectors; applying normalization and a multi-level perceptron (MLP) to the self-attention output; and generating a collection of one or more output hidden state vectors for each layer in the collection of self-attention-based transformer layers.
Aspect 12. The apparatus of aspects 8-11, wherein storing the final self-attention based hidden state output comprises storing a hidden state output from a last self-attention-based transformer layer before the generative model transitions to using cross-attention-based transformer layers.
Aspect 13. The apparatus of aspects 8-12, wherein applying the final self-attention based hidden state output to the collection of) cross-attention-based transformer layers extending from the transition layer index (+1) to the number of layers (N) comprises: determining a query (Q) vector from an output of a previous layer; determining a key (K) vector and a value (V) vector from the final self-attention based hidden state output; performing cross-attention computations using the Q vector, the K vector, and the V vector to generate a cross-attention output; applying normalization and a multi-level perceptron (MLP) to the cross-attention output; and generating a hidden state for each layer in the collection of cross-attention-based transformer layers.
Aspect 14. The apparatus of aspects 8-13, wherein generating the output tokens based on the final cross-attention based hidden state output from the final layer in the number of layers (N) comprises: computing final output token probabilities using the final cross-attention based hidden state output from the final cross-attention based transformer layer; applying a softmax function to obtain a probability distribution over a vocabulary; and sampling an output token from the probability distribution.
Aspect 15. A non-transitory computer-readable medium having stored thereon instructions that, when executed by at least one processor, cause the at least one processor to perform operations comprising: receiving an input prompt that is tokenized into a sequence of input tokens and converted into input embedding vectors; processing the input embedding vectors through a collection of self-attention-based transformer layers extending from a first layer to a transition layer index ( ); storing a final self-attention based hidden state output from the transition layer index (i) layer; applying the final self-attention based hidden state output to a collection of cross-attention-based transformer layers, where N is a number of layers, extending from the transition layer index (+1) to the number of layers to generate a final cross-attention based hidden state output; and generating output tokens based on the final cross-attention based hidden state output from the final layer in the number of layers (N).
Aspect 16. The non-transitory computer-readable medium of aspect 15, wherein when executed by the at least one processor, the instructions cause the at least one processor to perform operations comprising: determining model parameters for the generative model, wherein the model parameters include one or more of a number of layers (N), a hidden state size, or an attention head configuration; and setting the transition layer index ( ) to represent a layer at which the generative model transitions from self-attention based transformer layer to cross-attention based transformer layer.
Aspect 17. The non-transitory computer-readable medium of aspects 15-16, wherein when executed by the at least one processor, the instructions cause the at least one processor to perform operations comprising: classifying the received input prompt based on sensitivity of the output to index; and selecting one of a plurality of trained generative model models configured with different index values based on the classified received prompt, wherein processing the input prompt is performed using the selected one of the plurality of trained generative models.
Aspect 18. The non-transitory computer-readable medium of aspects 15-17, wherein processing the input embedding vectors through a collection of self-attention-based transformer layers extending from a first layer to a transition layer index ( ) comprises: computing query (Q), key (K), and value (V) vectors corresponding to each input hidden state vector, where the input hidden state vectors are the output hidden state vectors of a preceding self-attention-based transformer layer or the input embedding vectors; performing self-attention computations using the computed Q, K, V vectors; applying normalization and a multi-level perceptron (MLP) to the self-attention output; and generating a collection of one or more output hidden state vectors for each layer in the collection of self-attention-based transformer layers.
Aspect 19. The non-transitory computer-readable medium of aspects 15-18, wherein storing the final self-attention based hidden state output comprises storing a hidden state output from a last self-attention-based transformer layer before the generative model transitions to using cross-attention-based transformer layers.
Aspect 20. The non-transitory computer-readable medium of aspects 15-19, wherein applying the final self-attention based hidden state output to the collection of) cross-attention-based transformer layers extending from the transition layer index (+1) to the number of layers (N) comprises: determining a query (Q) vector from an output of a previous layer; determining a key (K) vector and a value (V) vector from the final self-attention based hidden state output; performing cross-attention computations using the Q vector, the K vector, and the V vector to generate a cross-attention output; applying normalization and a multi-level perceptron (MLP) to the cross-attention output; and generating a hidden state for each layer in the collection of cross-attention-based transformer layers.
Aspect 21. An apparatus including one or more means for performing operations according to any of Aspects 1-7.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be but is not limited to a process running on a processor, a processor, an object, an executable, a thread of execution, a program, and/or a computer. By way of illustration, both an application running on a computing device and the computing device may be referred to as a component. One or more components may reside within a process and/or thread of execution. A component may be localized on one processor or core and/or distributed between two or more processors or cores. In addition, these components may execute from various non-transitory computer-readable media with various instructions and/or data structures stored thereon. Components may communicate by way of local and/or remote processes, function or procedure calls, electronic signals, data packets, memory read/writes, and other known network, computer, processor, and/or process-related communication methodologies.

A number of different types of memories and memory technologies are available or contemplated in the future, any or all of which may be included and used in systems and computing devices that implement the various embodiments. Such memory technologies/types may include non-volatile random-access memories (NVRAM) such as Magnetoresistive RAM (M-RAM), resistive random-access memory (ReRAM or RRAM), phase-change random-access memory (PC-RAM, PRAM or PCM), ferroelectric RAM (F-RAM), spin-transfer torque magnetoresistive random-access memory (STT-MRAM), and three-dimensional cross point (3D-XPOINT) memory. Such memory technologies/types may also include non-volatile or read-only memory (ROM) technologies, such as programmable read-only memory (PROM), field programmable read-only memory (FPROM), one-time programmable non-volatile memory (OTP NVM). Such memory technologies/types may further include volatile random-access memory (RAM) technologies, such as dynamic random-access memory (DRAM), double data rate (DDR) synchronous dynamic random-access memory (DDR SDRAM), static random-access memory (SRAM), and pseudo-static random-access memory (PSRAM). Systems and computing devices that implement the various embodiments may also include or use electronic (solid-state) non-volatile computer storage mediums, such as FLASH memory. Each of the above-mentioned memory technologies include, for example, elements suitable for storing instructions, programs, control signals, and/or data for use in a computing device, system on chip (SOC) or other electronic component. Any references to terminology and/or technical details related to an individual type of memory, interface, standard or memory technology are for illustrative purposes only, and not intended to limit the scope of the claims to a particular memory system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with various embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with various embodiments disclosed herein may be implemented or performed with a general purpose processor, a digital signal processor (DSP), an application specific integrated circuit (TCUASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store target program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of improving operation of a computing system executing a generative model, comprising:
receiving an input prompt that is tokenized into a sequence of input tokens and converted into input embedding vectors;
processing the input embedding vectors through a collection of i self-attention-based transformer layers extending from a first layer to a transition layer index (i);
storing a final self-attention based hidden state output from the transition layer index (i) layer;
applying the final self-attention based hidden state output to a collection of (N−i) cross-attention-based transformer layers, where N is a number of layers, extending from the transition layer index (i+1) to the number of layers to generate a final cross-attention based hidden state output; and
generating output tokens based on the final cross-attention based hidden state output from the final layer in the number of layers (N).

2. The method of claim 1, further comprising:
determining model parameters for the generative model, wherein the model parameters include one or more of a number of layers (N), a hidden state size, or an attention head configuration; and
setting the transition layer index (i) to represent a layer at which the generative model transitions from self-attention based transformer layer to cross-attention based transformer layer.

3. The method of claim 1, further comprising:
classifying the received input prompt based on sensitivity of the output to index i; and
selecting one of a plurality of trained generative model models configured with different index values based on the classified received prompt,
wherein processing the input prompt is performed using the selected one of the plurality of trained generative models.

4. The method of claim 1, wherein processing the input embedding vectors through a collection of i self-attention-based transformer layers extending from a first layer to a transition layer index (i) comprises:
computing query (Q), key (K), and value (V) vectors corresponding to each input hidden state vector, where the input hidden state vectors are the output hidden state vectors of a preceding self-attention-based transformer layer or the input embedding vectors;
performing self-attention computations using the computed Q, K, V vectors;
applying normalization and a multi-level perceptron (MLP) to the self-attention output; and
generating a collection of one or more output hidden state vectors for each layer in the collection of i self-attention-based transformer layers.

5. The method of claim 1, wherein storing the final self-attention based hidden state output comprises storing a hidden state output from a last self-attention-based transformer layer before the generative model transitions to using cross-attention-based transformer layers.

6. The method of claim 1, wherein applying the final self-attention based hidden state output to the collection of (N−i) cross-attention-based transformer layers extending from the transition layer index (i+1) to the number of layers (N) comprises:
determining a query (Q) vector from an output of a previous layer;
determining a key (K) vector and a value (V) vector from the final self-attention based hidden state output;
performing cross-attention computations using the Q vector, the K vector, and the V vector to generate a cross-attention output;
applying normalization and a multi-level perceptron (MLP) to the cross-attention output; and
generating a hidden state for each layer in the collection of (N−i) cross-attention-based transformer layers.

7. The method of claim 1, wherein generating the output tokens based on the final cross-attention based hidden state output from the final layer in the number of layers (N) comprises:
computing final output token probabilities using the final cross-attention based hidden state output from the final cross-attention based transformer layer;
applying a softmax function to obtain a probability distribution over a vocabulary; and
sampling an output token from the probability distribution.

8. An apparatus for improving operation of a computing system executing a generative model, comprising:
at least one memory comprising instructions; and
at least one processor coupled to the at least one memory and configured to perform operations comprising:
receiving an input prompt that is tokenized into a sequence of input tokens and converted into input embedding vectors;
processing the input embedding vectors through a collection of i self-attention-based transformer layers extending from a first layer to a transition layer index (i);
storing a final self-attention based hidden state output from the transition layer index (i) layer;
applying the final self-attention based hidden state output to a collection of (N−i) cross-attention-based transformer layers, where N is a number of layers, extending from the transition layer index (i+1) to the number of layers to generate a final cross-attention based hidden state output; and
generating output tokens based on the final cross-attention based hidden state output from the final layer in the number of layers (N).

9. The apparatus of claim 8, wherein the processor is further configured to perform operations comprising:
determining model parameters for the generative model, wherein the model parameters include one or more of a number of layers (N), a hidden state size, or an attention head configuration; and
setting the transition layer index (i) to represent a layer at which the generative model transitions from self-attention based transformer layer to cross-attention based transformer layer.

10. The apparatus of claim 8, wherein the processor is further configured to perform operations comprising:
classifying the received input prompt based on sensitivity of the output to index i; and
selecting one of a plurality of trained generative model models configured with different index values based on the classified received prompt,
wherein processing the input prompt is performed using the selected one of the plurality of trained generative models.

11. The apparatus of claim 8, wherein processing the input embedding vectors through a collection of i self-attention-based transformer layers extending from a first layer to a transition layer index (i) comprises:
computing query (Q), key (K), and value (V) vectors corresponding to each input hidden state vector, where the input hidden state vectors are the output hidden state vectors of a preceding self-attention-based transformer layer or the input embedding vectors;
performing self-attention computations using the computed Q, K, V vectors;
applying normalization and a multi-level perceptron (MLP) to the self-attention output; and
generating a collection of one or more output hidden state vectors for each layer in the collection of i self-attention-based transformer layers.

12. The apparatus of claim 8, wherein storing the final self-attention based hidden state output comprises storing a hidden state output from a last self-attention-based transformer layer before the generative model transitions to using cross-attention-based transformer layers.

13. The apparatus of claim 8, wherein applying the final self-attention based hidden state output to the collection of (N−i) cross-attention-based transformer layers extending from the transition layer index (i+1) to the number of layers (N) comprises:
determining a query (Q) vector from an output of a previous layer;
determining a key (K) vector and a value (V) vector from the final self-attention based hidden state output;
performing cross-attention computations using the Q vector, the K vector, and the V vector to generate a cross-attention output;
applying normalization and a multi-level perceptron (MLP) to the cross-attention output; and
generating a hidden state for each layer in the collection of (N−i) cross-attention-based transformer layers.

14. The apparatus of claim 8, wherein generating the output tokens based on the final cross-attention based hidden state output from the final layer in the number of layers (N) comprises:
computing final output token probabilities using the final cross-attention based hidden state output from the final cross-attention based transformer layer;
applying a softmax function to obtain a probability distribution over a vocabulary; and
sampling an output token from the probability distribution.

15. A non-transitory computer-readable medium having stored thereon instructions that, when executed by at least one processor, cause the at least one processor to perform operations comprising:
receiving an input prompt that is tokenized into a sequence of input tokens and converted into input embedding vectors;
processing the input embedding vectors through a collection of i self-attention-based transformer layers extending from a first layer to a transition layer index (i);
storing a final self-attention based hidden state output from the transition layer index (i) layer;
applying the final self-attention based hidden state output to a collection of (N−i) cross-attention-based transformer layers, where N is a number of layers, extending from the transition layer index (i+1) to the number of layers to generate a final cross-attention based hidden state output; and
generating output tokens based on the final cross-attention based hidden state output from the final layer in the number of layers (N).

16. The non-transitory computer-readable medium of claim 15, wherein when executed by the at least one processor, the instructions cause the at least one processor to perform operations comprising:
determining model parameters for the generative model, wherein the model parameters include one or more of a number of layers (N), a hidden state size, or an attention head configuration; and
setting the transition layer index (i) to represent a layer at which the generative model transitions from self-attention based transformer layer to cross-attention based transformer layer.

17. The non-transitory computer-readable medium of claim 15, wherein when executed by the at least one processor, the instructions cause the at least one processor to perform operations comprising:
classifying the received input prompt based on sensitivity of the output to index i; and
selecting one of a plurality of trained generative model models configured with different index values based on the classified received prompt,
wherein processing the input prompt is performed using the selected one of the plurality of trained generative models.

18. The non-transitory computer-readable medium of claim 15, wherein processing the input embedding vectors through a collection of i self-attention-based transformer layers extending from a first layer to a transition layer index (i) comprises:
computing query (Q), key (K), and value (V) vectors corresponding to each input hidden state vector, where the input hidden state vectors are the output hidden state vectors of a preceding self-attention-based transformer layer or the input embedding vectors;
performing self-attention computations using the computed Q, K, V vectors;
applying normalization and a multi-level perceptron (MLP) to the self-attention output; and
generating a collection of one or more output hidden state vectors for each layer in the collection of i self-attention-based transformer layers.

19. The non-transitory computer-readable medium of claim 15, wherein storing the final self-attention based hidden state output comprises storing a hidden state output from a last self-attention-based transformer layer before the generative model transitions to using cross-attention-based transformer layers.

20. The non-transitory computer-readable medium of claim 15, wherein applying the final self-attention based hidden state output to the collection of (N−i) cross-attention-based transformer layers extending from the transition layer index (i+1) to the number of layers (N) comprises:
determining a query (Q) vector from an output of a previous layer;
determining a key (K) vector and a value (V) vector from the final self-attention based hidden state output;
performing cross-attention computations using the Q vector, the K vector, and the V vector to generate a cross-attention output;
applying normalization and a multi-level perceptron (MLP) to the cross-attention output; and
generating a hidden state for each layer in the collection of (N−i) cross-attention-based transformer layers.
